(19) United States
(12) Patent Application Publication
(10) Pub. No.: US 2013/0198476 A1
(43) Pub. Date: Aug. 1, 2013

(54) MANAGEMENT SYSTEM OF INFORMATION MEMORY SYSTEM AND MANAGEMENT METHOD THEREOF

(71) Applicants: Jun Nakajima, Yokohama (JP); Tsukasa Shibayama, Kawasaki (JP); Yukinori Sakashita, Sagamihara (JP)

(72) Inventors: Jun Nakajima, Yokohama (JP); Tsukasa Shibayama, Kawasaki (JP); Yukinori Sakashita, Sagamihara (JP)

(73) Assignee: Hitachi, Ltd.

(21) Appl. No.: 13/574,942

(22) PCT Filed: Jan. 26, 2012
(86) PCT No.: PCT/JP12/51646

§ 371 Date: Jul. 24, 2012

(51) Int. Cl. G06F 12/02

(52) U.S. Cl. 711/165; 711/E12.002

(57) ABSTRACT

Management method refers to position management information indicating an installation position of each of storage apparatuses. Positions of a first storage apparatus including a first volume and a second storage apparatus including a second volume composing a copy pair with the first volume are specified from the position management information. A positional relationship between the first and the second storage apparatuses before data migration is determined. If the second volume is not to be migrated, a condition of a positional relationship after the data migration to be satisfied between a migration destination storage apparatus of data of the first volume and the second storage apparatus is determined. Storage apparatus which satisfies at least the condition of the positional relationship after the data migration is selected from the storage apparatuses as the destination storage apparatus.

### BACKGROUND

The present invention relates to a management system of an information memory system and a management method thereof and particularly relates to management of data migration of a storage apparatus.

In recent years, enterprises generally own a plurality of information systems and data centers used for their business. Also, with the trend of globalization of business, the case in which the enterprises own a plurality of geographically-distributed information systems and data centers has been increasing. Accordingly, for improving capacity efficiency and facilitating data migration in use environments of the plurality of geographically distributed information systems and data centers, a uniform management technology such as a single storage pool has begun to spread.

Here, the term of the single storage pool refers to a single virtual resource pool, which aggregates resources across the physical boundary of, for example, storage apparatuses, data centers and the like, and is a technology for hiding a physical boundary for a business host and a business application on a host by allowing them to recognize only the virtual resource pool.

On the other hand, changes in the business process and businesses have become intense, and opportunities to reconstruct data centers by replacing old facilities by new facilities through scrap-and-build and transfer of data centers, offices or information systems for reduction of running cost, measures against decrepit buildings and facilities, enhancement of power supply facilities, appropriate installation of air conditioning, ensuring of spaces and the like have increased so that appropriate data migration has become important.

Technologies usable for such data migration include technologies in Patent Literature 1, Patent Literature 2 and the like. By using the technologies described in Patent Literatures 1 and 2, resource adjustment and data migration across data centers, considering capacity and performance after the data migration, can be realized.
Patent Literature 1: U.S. Pat. No. 7,801,994
Patent Literature 2: U.S. Pat. No. 7,970,903

### SUMMARY

While the technologies as in Patent Literatures 1 and 2 have been proposed, not only the capacity and performance but other various viewpoints need to be considered in data migration process, and that makes data migration works extremely difficult.

For example, in the case of data migration of a system in which a disaster recovery construction or a remote backup construction is made from the viewpoints of high reliability, tolerance against disasters and the like, which are particularly important in a large-scale system, such a problem occurs that a construction having an intentional configuration across boundaries such as data centers cannot be correctly migrated, and the configuration after the migration no longer makes sense.

If data migration is manually handled using a data migration service or the like, it takes long time from prior planning to execution in general, and in addition, risks including failures, information leakage or the like caused by operation errors due to insufficient understanding of the entire system are extremely high, which is also a problem.

An aspect of the present invention is a management system including a memory apparatus and a processor for managing an information storage system including a plurality of storage apparatuses. The memory apparatus stores position management information indicating an installation position of each of the plurality of storage apparatuses. The processor specifies a position of a first storage apparatus including a first volume and a position of a second storage apparatus including a second volume composing a copy pair with the first volume from the position management information. The processor determines a positional relationship between the first storage apparatus and the second storage apparatus before data migration from the specified position of the first storage apparatus and the specified position of the second storage apparatus. In a case where the second volume is not to be migrated, the processor determines a condition of a positional relationship after the data migration to be satisfied between a migration destination storage apparatus of data of the first volume and the second storage apparatus based on the positional relationship before the data migration. The processor selects a storage apparatus which satisfies at least the condition of positional relationship after the data migration from the plurality of storage apparatuses as a candidate of the migration destination storage apparatus.

According to one aspect of the present invention, a candidate for the more appropriate migration destination storage apparatus can be selected in data migration of a volume.

### BRIEF DESCRIPTION OF THE DRAWINGS

FIG. 1 is a block diagram illustrating a construction of a computer system of a first embodiment of the present invention.

FIG. 2 is a block diagram illustrating a construction of a management server of the first embodiment of the present invention.

FIG. 3 is a block diagram illustrating a construction of a storage apparatus of the first embodiment of the present invention.

FIG. 4 is a block diagram illustrating a construction of a physical server of the first embodiment of the present invention.

FIG. 5 is a block diagram illustrating a logical construction of a storage system having a configuration across data centers of the first embodiment of the present invention.

FIG. 6 is a diagram illustrating a location table stored in an information repository of the first embodiment of the present invention.

FIG. 7 is a diagram illustrating an inter-data-center table stored in the information repository of the first embodiment of the present invention.

FIG. 8 is a diagram illustrating a pair configuration table stored in the information repository of the first embodiment of the present invention.

FIG. 9 is a diagram illustrating a pair performance table stored in the information repository of the first embodiment of the present invention.

FIG. 10 is a diagram illustrating a usable function table stored in the information repository of the first embodiment of the present invention.

FIG. 11 is a diagram illustrating a work independent relationship information table stored in the information repository of the first embodiment of the present invention.

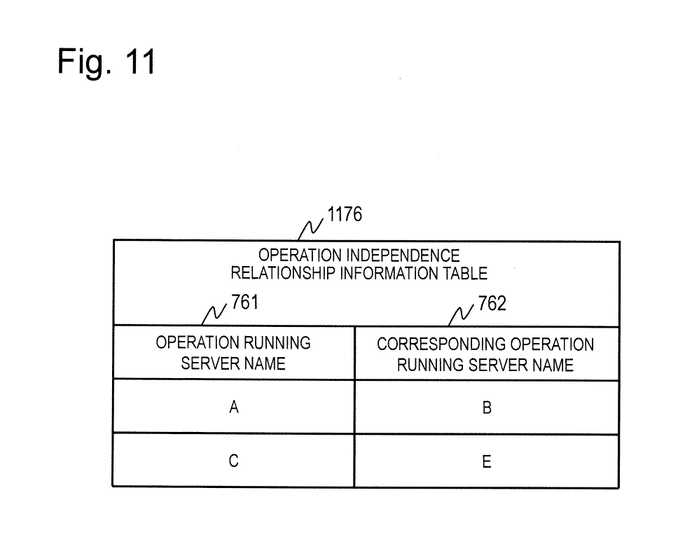

FIG. 12 is a diagram illustrating a construction information table stored in the information repository of the first embodiment of the present invention.

FIG. 13 is a diagram illustrating a pool information table stored in the information repository of the first embodiment of the present invention.

FIG. 14 is a flowchart illustrating a data migration destination presentation processing by the management server of the first embodiment of the present invention.

FIG. 15 is a flowchart illustrating a data migration destination determination processing by the management server of the first embodiment of the present invention.

FIG. 16 is a flowchart illustrating a destination narrowing processing on the pair-configuration basis by the management server of the first embodiment of the present invention.

FIG. 17 is a flowchart illustrating a narrowing processing based on positional information by the management server of the first embodiment of the present invention.

FIG. 18 is a flowchart illustrating a processing on a pair configuration not across data centers by the management server of the first embodiment of the present invention.

FIG. 19 is a flowchart illustrating a narrowing processing based on a line performance by the management server of the first embodiment of the present invention.

FIG. 20 is a flowchart illustrating narrowing processing based on a function by the management server of the first embodiment of the present invention.

FIG. 21 is a flowchart illustrating a migration destination narrowing processing on the performance independent requirement basis by the management server of the first embodiment of the present invention.

FIG. 22 is a flowchart illustrating a migration destination narrowing processing on the availability basis by the management server of the first embodiment of the present invention.

FIG. 23 is a flowchart illustrating a migration destination narrowing processing on the capacity basis by the management server of the first embodiment of the present invention.

FIG. 24 is a flowchart illustrating a data center information collection processing by the management server of the first embodiment of the present invention.

FIG. 25 is a diagram illustrating an example of a data migration destination selection/confirmation screen before narrowing the candidates of data migration destination presented to an administrator in the first embodiment of the present invention.

FIG. 26 is a diagram illustrating an example of the data migration destination selection/confirmation screen before data migration presented to an administrator in the first embodiment of the present invention.

FIG. 27 is a diagram illustrating an example of the data migration destination selection/confirmation screen after data migration presented to an administrator in the first embodiment of the present invention.

FIG. 28 is a diagram illustrating an example of an error screen during narrowing of the candidates of data migration destination presented to an administrator in the first embodiment of the present invention.

FIG. 29 is a block diagram illustrating a logical construction of a storage system having configuration across data centers of a second embodiment of the present invention.

FIG. 30 is an explanatory diagram illustrating a pair configuration table stored in an information repository of the second embodiment of the present invention.

FIG. 31 is a flowchart illustrating narrowing processing based on positional information by a management server of the second embodiment of the present invention.

FIG. 32 is a flowchart illustrating data migration destination presentation processing by the management server of the second embodiment of the present invention.

FIG. 33 is a block diagram illustrating a logical construction of a storage system having configuration across data centers of a third embodiment of the present invention.

FIG. 34 is an explanatory diagram illustrating a location table stored in an information repository of the third embodiment of the present invention.

FIG. 35 is a flowchart illustrating data migration destination determination processing by a management server of the third embodiment of the present invention.

FIG. 36 is a flowchart illustrating migration destination narrowing processing on the cloud form base by the management server of the third embodiment of the present invention.

FIG. 37 is a diagram illustrating an example of a data migration destination selection/confirmation screen before narrowing the candidates of data migration destination presented to the manager in the third embodiment of the present invention.

### DETAILED DESCRIPTION OF THE EMBODIMENTS

Embodiments of the present invention will be described below in detail by using the attached drawings. The present invention is not limited to the detailed procedure of processing described below but may use any procedures as long as the result of each processing is the same.

Also, in the following description, expressions including “aaa table” will be used in explanation of information of the present invention, but the information does not necessarily have to have a table structure but may be expressed in a data structure such as a list, a DB, a queue and the like. Thus, the “aaa table” and the like might be referred to as “aaa information” in order to indicate that it is not bound to a particular data structure.

Moreover, in the following description, processing might be described by using a “program” as a subject, but since a program is executed by a processor so that it performs determined processing while using a memory and a communication port (communication control device), a subject in the description may be considered to be a “processor”. Moreover, the processing disclosed by using the program as a subject may be the processing executed by a computer such as a management server and an information processing unit.

A part of or the whole of a program may be implemented by dedicated hardware. Alternatively, various programs may be installed in each computer with a program distribution server or a memory media readable by a computer.

A management server of this embodiment has an input device and an output device as will be described later. The input device and the output device may be a display, a keyboard, and a pointer device, for example, or may be other devices.

As alternatives of the input device and the output device, a serial interface or an Ethernet interface may be used as an input/output device. Input and display by an input/output device may be replaced by performing displaying with and receiving input from a computer for display, which has a display, a keyboard or a pointer device and is connected to these interfaces, through transmitting information for display to the computer for display and receiving information for input from the computer for display.

Hereinafter, in the case the management server displays the information for display, the management server is the management system and a combination of the management server and the computer for display is also the management system. Furthermore, processing equal to the management server may be realized with a plurality of computers for enhancing speed and reliability of management processing, and in the case the plurality of computers are the management system.

### First Embodiment

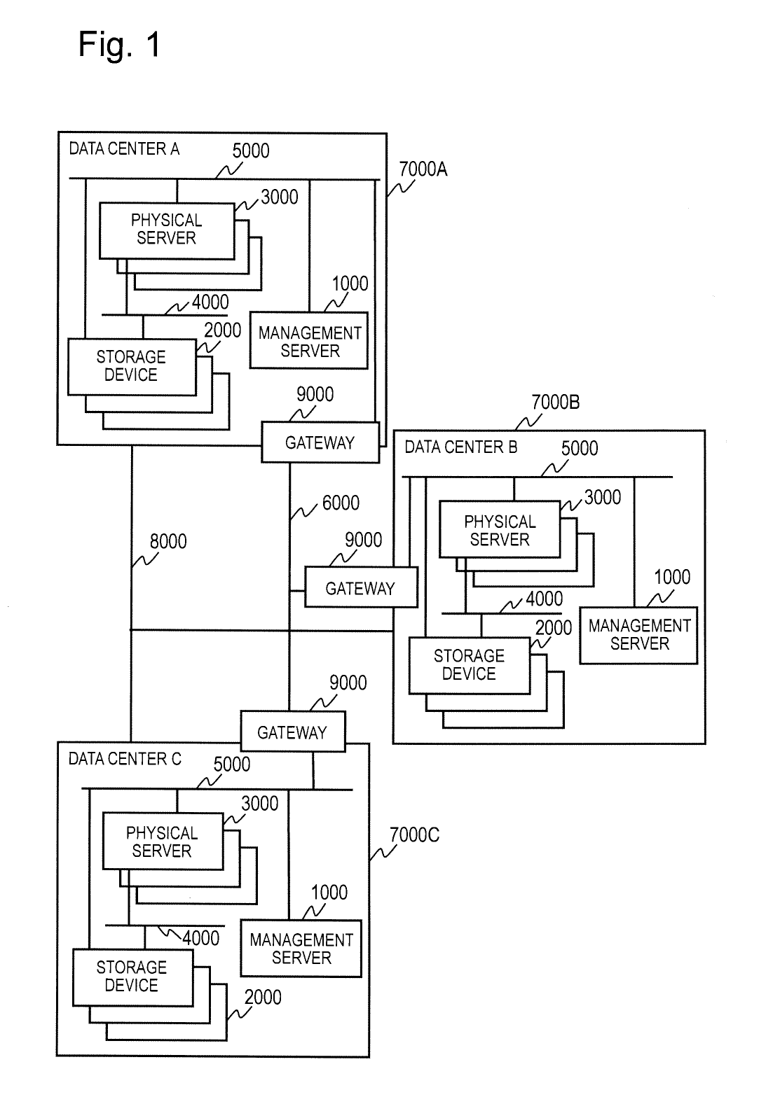

A construction of a computer system of this embodiment including a storage area network (SAN) and a plurality of storage apparatuses and a server connected to SAN will be described. FIG. 1 is a block diagram illustrating a construction of the computer system of a first embodiment of the present invention.

In the computer system in the first embodiment, a plurality of data centers 7000A, 7000B, and 7000C are connected to each other via a gateway 9000 for communication through a management network 6000. The data centers 7000A, 7000B, and 7000C are facilities, each in which a storage apparatus is installed, and are distributed geographically in general. The management network 6000 may be an arbitrary network type such as WAN (wide area network), LAN (local area network) and the like.

Each of the data centers 7000A, 7000B, and 7000C has a management server 1000, at least one storage apparatus 2000, and at least one physical server 3000. In this example, an information system including a plurality of storage apparatuses 2000 and the physical servers 3000 are included. The physical server 3000 is a computer. The gateway 9000 performs conversion processing between a network protocol used within the data center and a network protocol used for communication between the data centers.

Moreover, the plurality of data centers 7000A, 7000B, and 7000C are connected to each other for data communication via a data network 8000, and the data network 8000 may be of an arbitrary type such as SAN and may use the same network as the management network 6000.

The storage apparatus 2000 creates a plurality of logical volume. The created logical volume is provided to the physical server 3000. The physical server 3000 executes various operations by using the logical volume provided by the storage apparatus 2000. In the construction diagram illustrated in FIG. 1, the physical server 3000 and the storage apparatus 2000 are connected to each other via a fiber channel 4000.

In each of the data centers 7000A, 7000B, and 7000C, the management server 1000, the storage apparatus 2000, and the physical servers 3000 are connected via a management network 5000. The management server 1000 communicates with a program in the storage apparatus 2000 and the physical server 3000 via the management network 5000.

The connection between the storage apparatus 2000 and the physical server 3000 is not limited to direct connection via the fiber channel 4000 but may be connection via a network instrument such as one or more fiber channel switches. Moreover, the connection between the storage apparatus 2000 and the physical server 3000 may be connection via a network for data communication or may be connection via an IP network, for example.

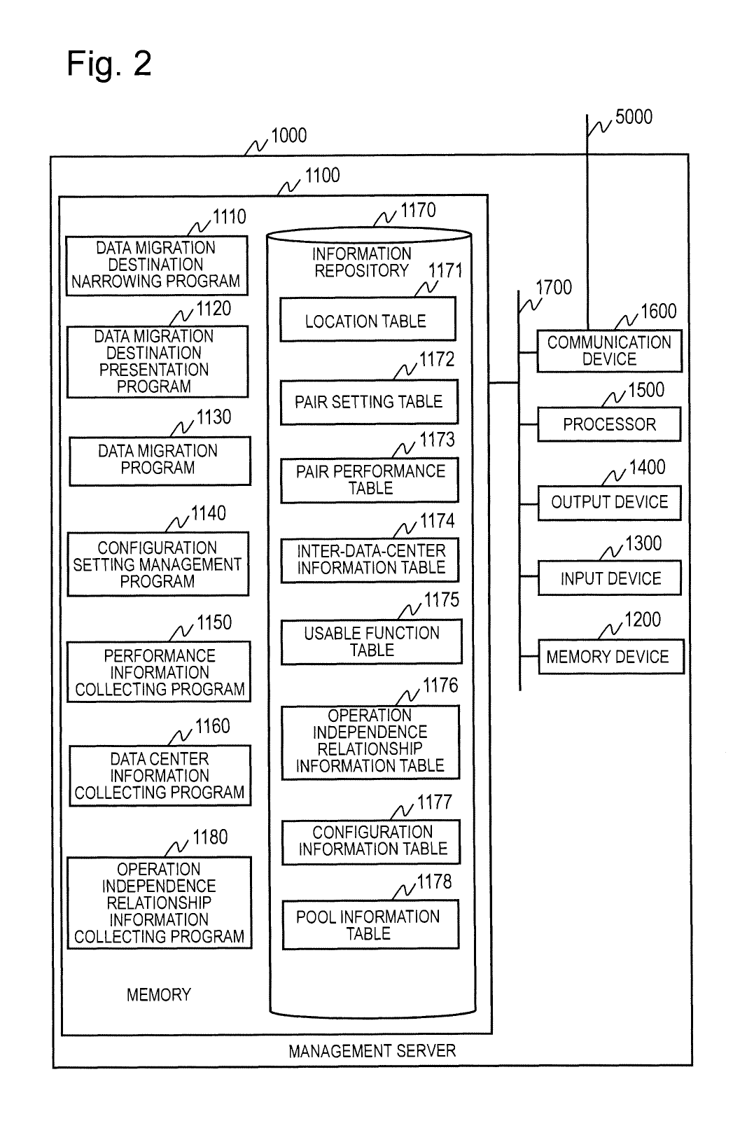

FIG. 2 is a block diagram illustrating a physical construction of the management server 1000 of the first embodiment of the present invention. The management server 1000 has a memory 1100, a memory device 1200, an input device 1300, an output device 1400, a processor 1500, and a communication device 1600. These devices are connected to each other via an internal bus 1700.

The memory 1100 stores a data migration destination narrowing program 1110, a data migration destination presentation program 1120, a data migration program 1130, a construction configuration management program 1140, a performance information collecting program 1150, a data center information collecting program 1160, an operation independence relationship information collecting program 1180, and an information repository 1170.

The data migration destination narrowing program 1110 executes processing of selecting a migration destination appropriate for a data migration target. The data migration destination presentation program 1120 executes processing of displaying a data migration source, a data migration destination candidate, and a state after data migration on a screen. The data migration program 1130 executes migration of data by using a data migration function of the storage apparatus 2000 upon receiving an instruction to migrate data.

The construction configuration management program 1140 executes referring/configuration processing for construction information in the system. The performance information collecting program 1150 executes referring/configuration processing for performance information in the system. The data center information collecting program 1160 obtains information for data center in the system. The operation independence relationship information collecting program 1180 obtains information of a plurality of operations requiring independence relationship on performances.

Hereinafter, it is assumed that the respective programs in each data center work in coordination with each other and share required information. The information repository 1170 stores a location table 1171, a pair configuration table 1172, a pair performance table 1173, an inter-data-center information table 1174, a usable function table 1175, an operation independence relationship information table 1176, a construction information table 1177, and a pool information table 1178.

The location table 1171 includes the storage apparatus 2000 present in the storage system and information indicating a correspondence on which of the data centers each storage apparatus 2000 is arranged. The pair configuration table 1172 includes information indicating a pair relationship having been configured in the computer system.

The pair performance table 1173 includes information indicating a history average value of IO performance between the configured pairs. The inter-data-center information table 1174 includes information indicating a spec value of line performance between the data centers, an actually measured value, and a distance between the data centers. The usable function table 1175 includes information indicating what functions are held by each storage apparatus. The operation independence relationship information table 1176 includes information indicating a relationship of a plurality of operations requiring independence on performances, if there are any.

The construction information table 1177 includes information indicating a resource arranged in each I/O path. Here, the I/O path in this embodiment is a path from the physical server 3000 to a physical disk in which a logical volume to be used by the physical server 3000 is created. The physical server 3000 transmits data to the logical volume or receives data from the logical volume via the I/O path. The resource in this embodiment refers to all the devices, apparatuses, networks and the like in the computer system of this embodiment. That is, the resource refers to all the devices, apparatuses, networks and the like to be monitored by the management server 1000.

The pool information 1178 includes information of free space of each pool in the storage apparatus present in the storage system, information of capacity of each volume having been created from each pool, and information indicating RAID level of the pool.

The memory device 1200 is an HDD (Hard Disk Drive), an SSD (Solid State Drive) and the like which store information. The input device 1300 is a keyboard, a mouse or the like used by an SAN administrator to input an instruction to data migration destination determination narrowing program 1110 or the like.

The output device 1400 is a display, a printer or the like which outputs an input request by an SAN administrator for sending an instruction to the data migration destination determination narrowing program 1110 for an administrator or the like. The processor 1500 executes a program expanded on the memory 1100. The communication device 1600 is a device which connects the management network 5000 to the processor 1500 and the like.

The programs and the tables illustrated in FIG. 2 are illustrated within the memory 1100 but they are typically loaded from the memory device 1200 or other memory mediums (not shown) to the memory 1100. The processor 1500 reads out the programs and tables on the memory 1100 when executing the programs and executes the read-out programs.

Moreover, the memory in the storage apparatus 2000 or the physical server 3000 may store the programs and tables illustrated in FIG. 2 and the storage apparatus 2000 or the physical server 4000 may execute the programs stored in their own memory. Moreover, other servers (not sown) or other apparatuses such as a switch (not shown) may have the programs and the tables illustrated in FIG. 2 and execute their own programs. In these constructions, the apparatus which executes the programs illustrated in FIG. 2 is included in the management system.

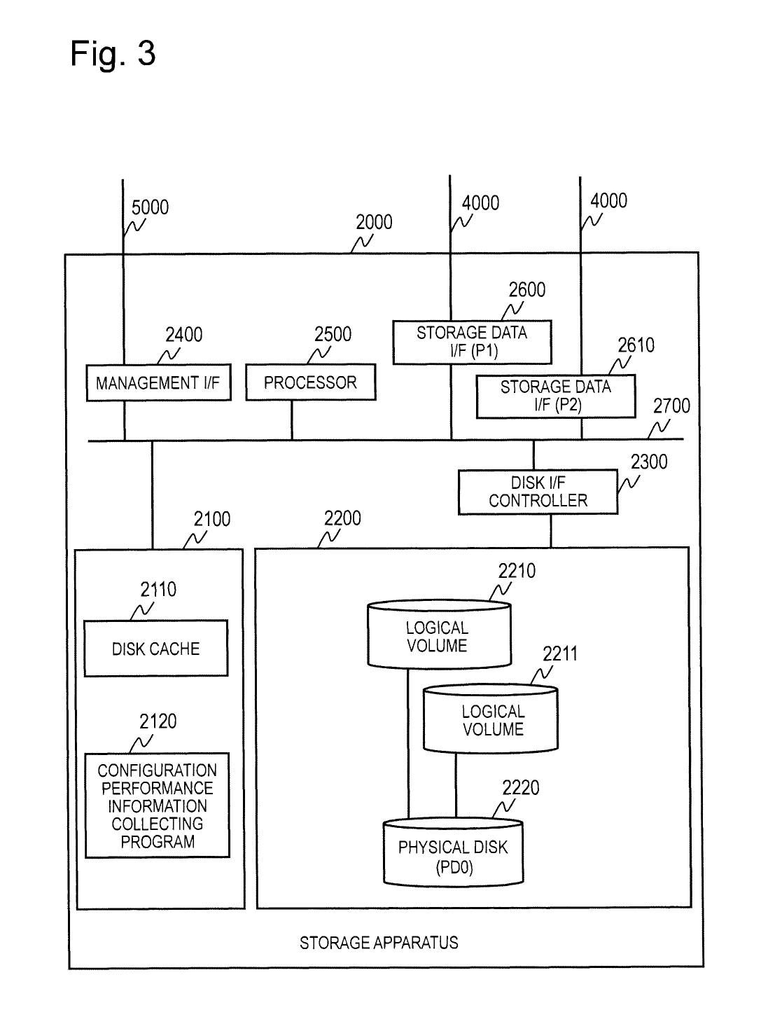

FIG. 3 is a block diagram illustrating a construction of the storage apparatus 2000 in the first embodiment of the present invention. The storage apparatus 2000 includes a memory 2100, a logical volume providing part 2200, a disk I/F controller 2300, a management I/F 2400, a processor 2500, and a storage data I/F 2600/2610, and these apparatuses are connected via a communication path 2700 such as an internal bus.

The memory 2100 includes a disk cache 2110 or stores a construction performance information collecting program 2120. The disk cache 2110 is a memory region which temporarily stores information. The construction performance information collecting program 2120 is a program which transmits/receives management information and performance information of the storage apparatus 2000 and resources of the storage apparatus 2000 between the storage apparatus 2000 and the management server 1000. That is, the construction performance information collecting program 2120 transmits a change, a failure and the like of the construction occurring in the storage apparatus 2000 to the management server 1000.

The logical volume providing part 2200 has one or more physical disks (also referred to as a memory drive). The physical disk 2220 is typically an HDD or an SSD but may be any type.

The logical volume providing part 2200 logically divides the memory regions of one or more physical disks 2220 and provides the logically divided memory regions as logical volumes to the physical server 3000 and the like. As a result, the logical volume providing part 2200 allows an apparatus other than the storage apparatus 2000, for example, or a physical server 3000 to access the logical volume. Physical disk numbers are assigned to the physical disks 2220, and logical volume numbers are assigned to the logical volumes. As a result, the storage apparatus 2000 can uniquely identify each physical disk 2220 and each logical volume.

The logical volume providing part 2200 illustrated in FIG. 3 has the physical disk 2220 (PD0) and logically divides the physical disk 2220 (PD0). The logical volume providing part 2200 provides two logical volumes 2210 and 2211 created by the division to an apparatus other than the storage apparatus 2000, for example, the physical server 3000.

The disk I/F controller 2300 is an interface which connects the logical volume providing part 2200 to the processor 2500 and the like. The management I/F 2400 is an interface which connects the management network 5000 to the processor 2500 and the like. The processor 2500 executes the program expanded on the memory 2100. The storage data I/F 2600 and 2610 is an interface which connects the fiber channel 4000 to the processor 2500 and the like. The numbers of the disk I/F controllers, the managements I/F, and the storage data I/F depend on design.

The construction performance information collecting program 2120 illustrated in FIG. 3 is stored in the memory 2100 but may be stored in other memory apparatus (not shown) or other memory medium (not shown). If the construction performance information collecting program 2120 is stored in other memory apparatus or other memory medium, the processor 2500 reads out the construction performance information collecting program 2120 into the memory 2100 when executing the processing and executes the read-out program.

The construction performance information collecting program 2120 may be stored in the memory of the management server 1000 or the memory of the physical server 3000, and the management server 1000 or the physical server 3000 may execute the construction performance information collecting program 2120 stored in their own memory. Alternatively, the construction performance information collecting program 2120 may be stored in another storage apparatus 2000 (not shown), and this storage apparatus 2000 may execute the construction performance information collecting program 2120 stored in itself.

The logical volume providing part 2200 may crate the logical volume 2210 by logically dividing a RAID group having a plurality of the physical disks 2220. The logical volume providing part 2200 may create the logical volume 2210 by assigning the whole memory region in one physical disk 2220 to one logical volume 2210. The logical volume providing part 2200 may create the logical volume 2210 from a memory region of a memory medium other than the physical disk 2220 such as a flash memory.

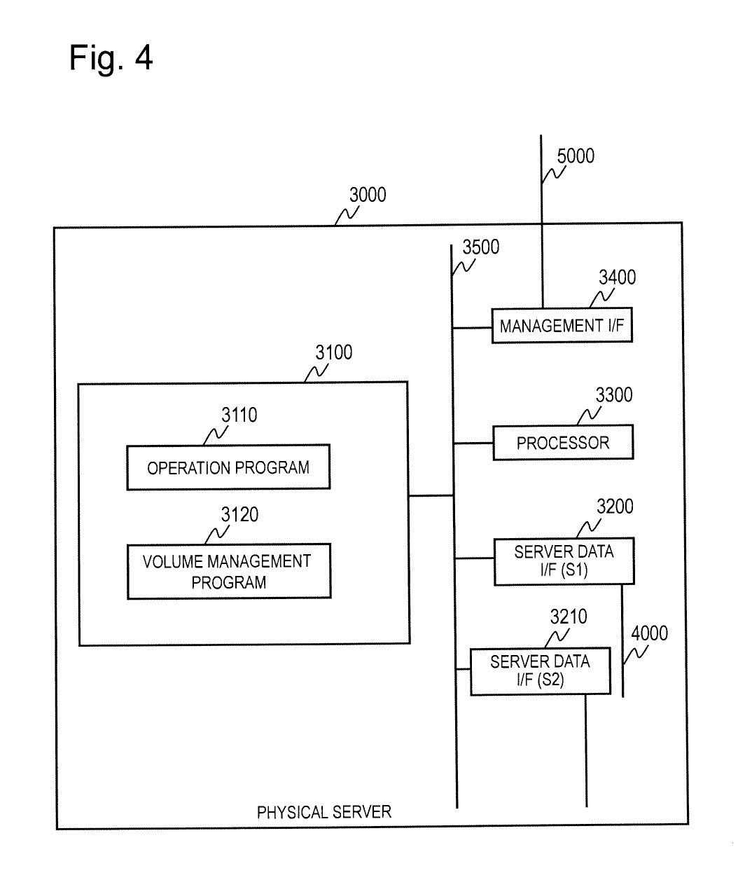

FIG. 4 is a block diagram illustrating a construction of the physical server 3000 in the first embodiment of the present invention. The physical server 3000 has a memory 3100, a server data I/F 3200, 3210, a processor 3300, and a management I/F 3400, and these apparatuses are connected to each other via an internal bus 3500. The memory 3100 stores an operation program 3110 and a volume management program 3120.

The operation program 3110 is a program for realizing an operation executed by the server 3120 and is a DBMS (Data Base Management System), a file system, or the like. The volume management program 3120 is a program for assigning the logical volume 2210 provided by the SAN to the server 3000.

The physical server 3000 executes an operation with the operation program 3110 using the logical volume 2210 assigned by the volume management program 3120. The server data I/F 3200 is an interface which connects the fiber channel 4000 to the processor 3300 and the like. The processor 3300 executes a program loaded to the memory 3100. The management I/F 3400 is an interface which comets the management network 5000 to the processor 3300 and the like.

The server data I/F 3200 and the management I/F 3400 may be provided in plural. The program illustrated in FIG. 4 is stored in the memory 3100 but may be stored in other memory apparatus (not shown) or other memory medium (not shown). If the program illustrated in FIG. 4 is stored in other memory apparatus or other memory medium, the processor 3300 reads out the program illustrated in FIG. 4 into the memory 3100 when executing the processing and executes the read-out program.

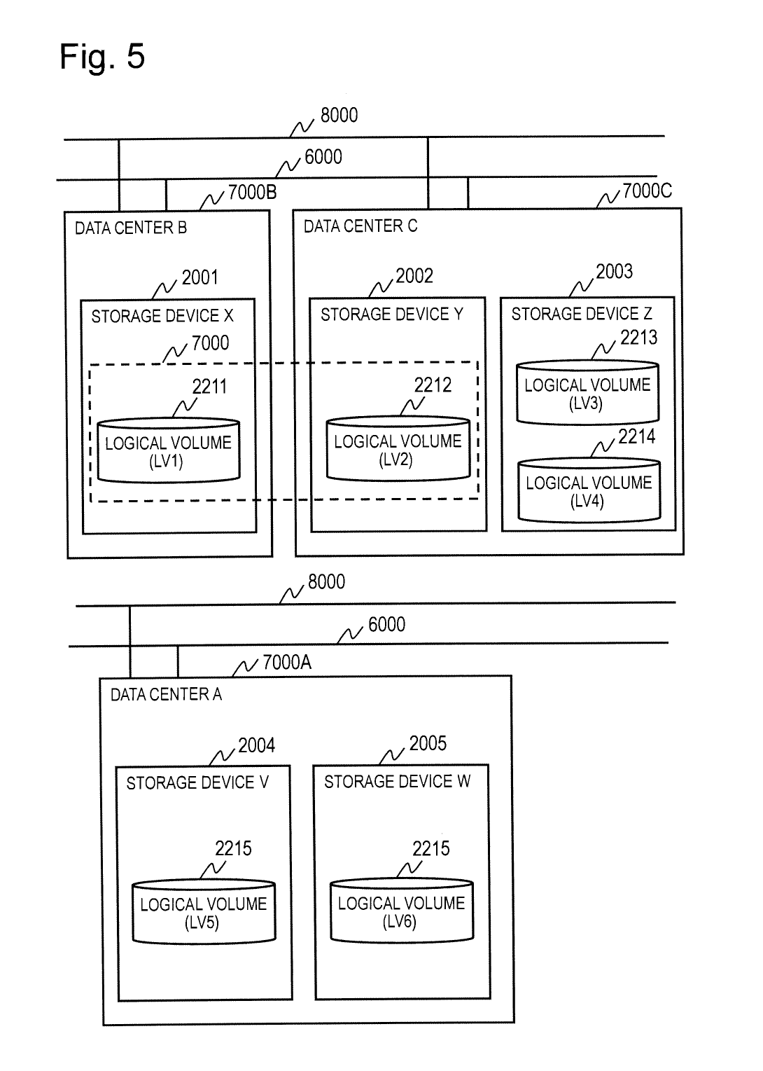

FIG. 5 is a block diagram illustrating a logical construction example across the data centers, that is, the case in which associated volumes are located in different data centers of the first embodiment of the present invention.

FIG. 5 illustrates that a pair relationship of remote copy (copy pair 7000) is configured between a logical volume 2211 (LV1) in a storage apparatus 2001 (storage apparatus X) arranged in the data center 7000B and a logical volume 2212 (LV2) in a storage apparatus 2002 (storage apparatus Y) arranged in the data center 7000C.

Here, the remote copy maintains strict correspondence between the volumes of two or more storage apparatuses and executes a read/write operation with respect to the volume of a primary storage apparatus, in a duplicated manner, in the volume of a secondary storage apparatus. If processing in the primary storage apparatus fails for some reason, the secondary storage apparatus takes over the processing and can operate in place of the primary storage apparatus.

The remote copy is roughly classified to synchronous copy and asynchronous copy. A function in which a response to an operation host concerning the writing into the volume of the primary storage apparatus is performed after the writing into the volume of the secondary storage apparatus is called synchronous copy. A function in which a response to the operation host concerning the writing into the volume of the primary storage apparatus is performed before the write into the volume of the secondary storage apparatus is completed is called asynchronous copy.

In this embodiment, the copy pair 7000 is supposed to be a copy pair of synchronous copy, but the type of the copy pair 7000 may be either of the synchronous copy and the asynchronous copy, and this limitation does not limit application of the present invention.

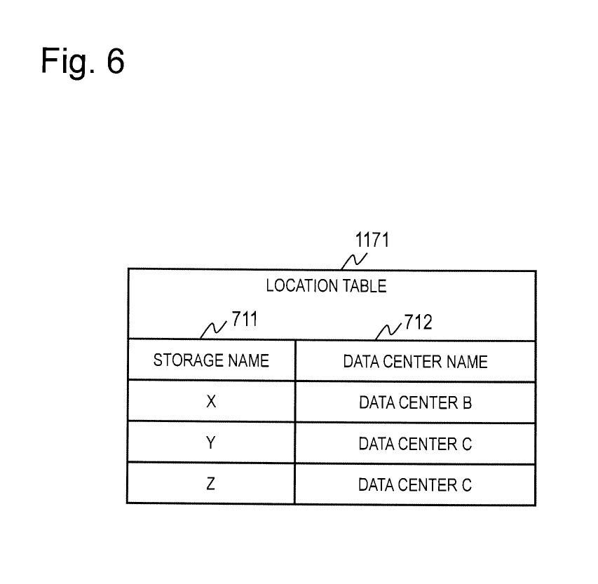

FIG. 6 is a diagram illustrating the location table 1171 stored in the information repository 1170 of the first embodiment of the present invention. The location table 1171 includes storage apparatuses present in the computer system and information indicating a correspondence between each storage apparatus and the data center. The data center information collecting program 1160 executes position information obtaining processing, whereby information is added to the location table 1171.

The location table 1171 includes a storage name column 711 and a data center name column 712. The storage name column 711 stores identifiers identifying the storage apparatus, and the data center name column 712 stores identifiers identifying the data centers.

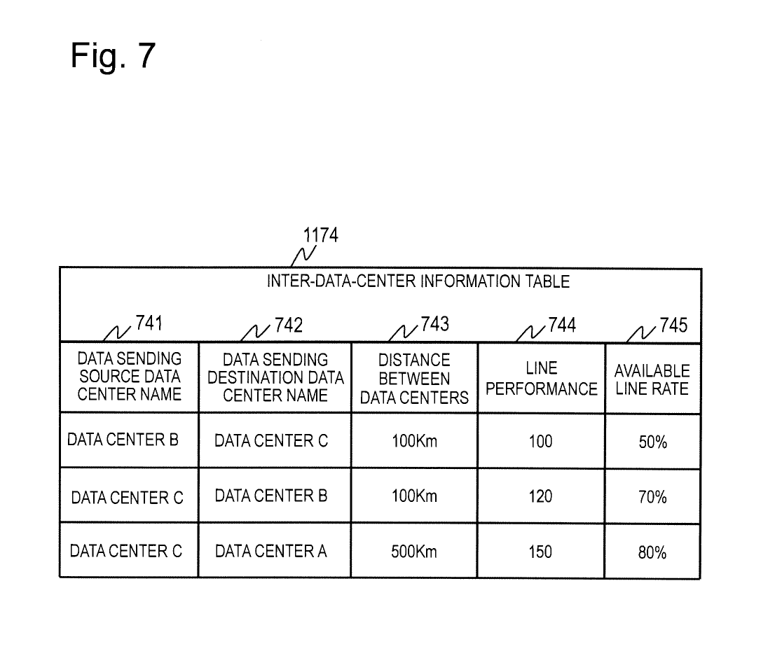

FIG. 7 is a diagram illustrating inter-data-center information table 1174 stored in the information repository 1170. The inter-data-center information table 1174 includes information indicating a spec value of line performance between the data centers, an actually measured value, and a distance between the data centers. The data center information collecting program 1160 collects/calculates information of line performance and a distance between the data centers and adds a record to the inter-data-center information table 1174.

The inter-data-center information table 1174 includes a data sending source data center name column 741, a data sending destination data center column 742, an inter-data-center distance column 743, a line performance column 744, and an available line rate column 745. The inter-data-center information table 1174 is a table indicating line information between each of the data centers present in the computer system.

The data sending source data center name column 741 and the data sending destination data center column 742 store information of identifiers indicating each data center. Here, the data sending source data center name column 741 and the data sending destination data center column 742 store different data center names.

Each field in the inter-data-center distance column 743 stores information of distance between data centers in the data sending source data center name column 741 and the data centers of the data sending destination data center column 742. In this example, an example of storing a physical distance is stored as distance information, but the number of hops of the apparatuses such as a logical switch through which the data is routed.

A spec value of the line performance in data transfer, supposing that the data center indicated by the information stored in the data sending source data center name column 741 is configured as the copy sources and the data centers indicated by the information stored in the data sending destination data center column 742 is configured as the copy destination, is stored in the line performance column 744, and an actually measured value of line performance in data transfer is stored in the available line rate column 745.

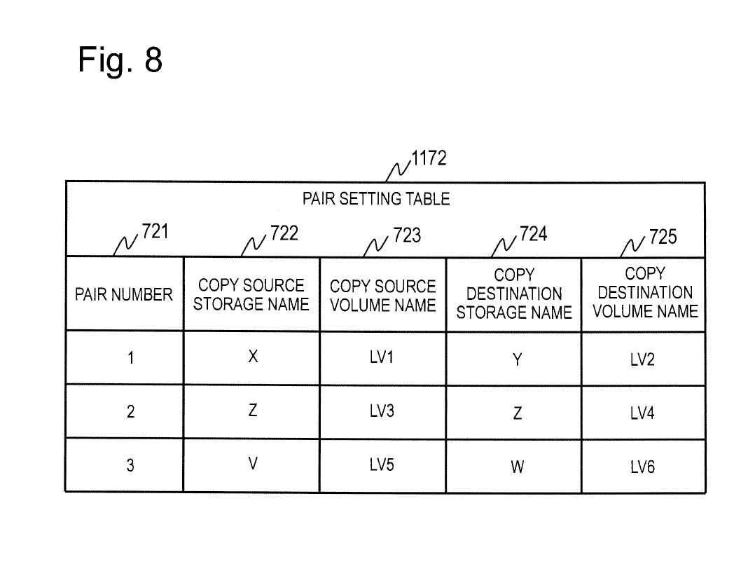

The pair configuration table 1172 illustrated in FIG. 8 includes information indicating pair relationship having been configured in the computer system. The construction configuration management program 1140 collects information of the copy pairs in collaboration with the construction performance information collecting program 2120 of the storage apparatus 2000 and the construction configuration management programs 1140 in other data centers and adds a record to the pair configuration table 1172.

The pair configuration table 1172 includes a pair number column 721, a copy source storage name column 722, a copy source volume name column 723, a copy destination storage name column 724, and a copy destination volume name column 725. The pair number column 721 stores identifiers indicating pairs and the copy source storage name column 722 stores identifiers of storage apparatuses which are copy sources of the pairs.

The copy source volume name column 723 stores identifiers of the volumes which become the copy sources of the pairs and the copy destination storage name column 724 stores identifiers of the storage apparatuses which become the copy destinations of the pairs, and the copy destination volume name column 725 stores identifiers of the volumes which become the copy destinations of the pairs.

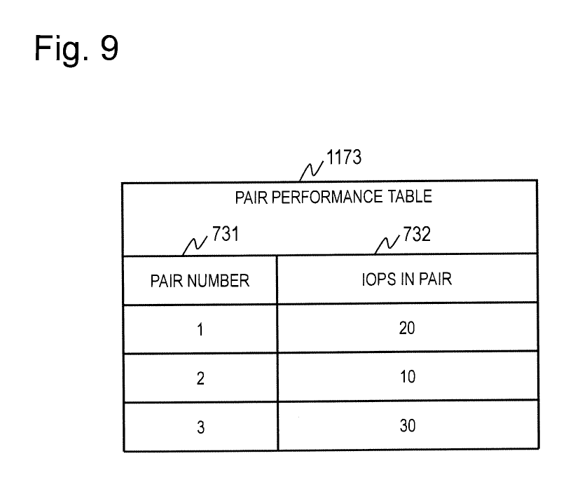

The pair performance table 1173 illustrated in FIG. 9 includes information indicating a history average value of I/O performance between the pairs having been configured. The performance information collecting program 1150 collects the performance information of the copy pairs in collaboration with the construction performance information collecting program 2120 of the storage apparatus 2000 and adds a record to the pair performance table 1173.

The pair performance table 1173 includes a pair number column 731 and an IOPS in pair column 732. The pair number column 731 stores identifiers indicating a pair and the IOPS in pair column 732 stores an average value of values indicating the number of I/O transferred from the primary storage apparatus to the secondary storage apparatus of volumes composing a pair per unit of time for a past fixed period, for example the past 1 hour. Here, the performance information is used as IOPS, but any other performance values such as response performance may be used.

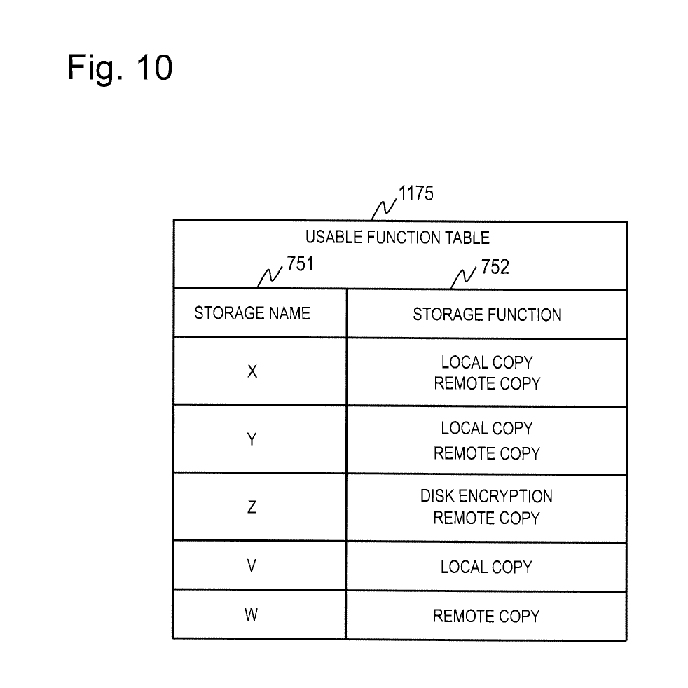

The usable function table 1175 illustrated in FIG. 10 includes information indicating what functions are held by each storage apparatus. The construction configuration management program 1140 collects function information held by each storage apparatus in collaboration with the construction performance information collecting program 2120 of the storage apparatus 2000 and the construction configuration management program 1140 in other data centers and adds a record to the usable function table 1175.

The usable function table 1175 includes a storage name column 751 and a storage function column 752. The storage name column 751 stores identifiers indicating the storage apparatuses and the storage function column 752 stores values indicating what functions are held by the storage apparatus indicated in the storage name column 751. For example, information on whether or not the storage apparatus holds a remote copy function, whether or not a disk encryption function is stored, and the like is stored.

The operation independence relationship information table 1176 includes information indicating a relationship if there are a plurality of operations requiring independence on performances. An operation independence relationship information collecting program 1187 collects information on necessity of independence of an operation from the software specified by a user or from software which sorts processing.

The operation independence relationship information table 1176 includes an operation running server name column 761 and a corresponding operation running server name column 762. The operation serving server name column 761 stores identifiers indicating servers on which operations requiring independence on performance are running, and the corresponding operation running server name column 762 stores identifies indicating servers on which operations requiring independence on performance from the server of the operation running server name column 761.

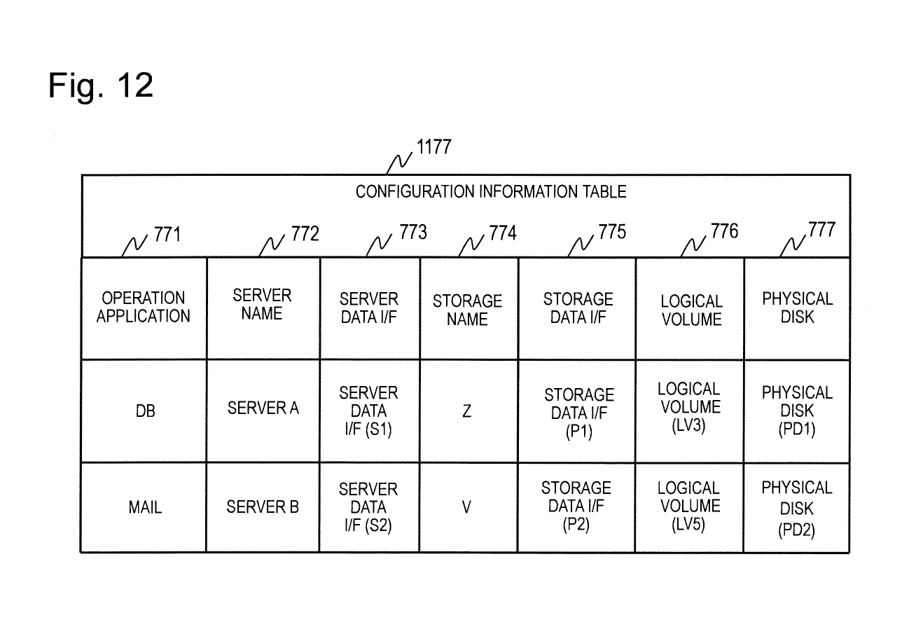

The construction information table 1177 illustrated in FIG. 12 includes information indicating a resource arranged in each I/O path. The construction information table 1177 stores information of resources included in the paths between the physical server 3000 and the physical disk 2220 in which the logical volume 2210 provided to the physical server 3000 is created. If the physical server 3000 makes an access to the logical volume 2210, the physical server 3000 communicates with the logical volume 2210 via the resource whose information is stored in the construction information table 1177.

When the construction configuration management program 1140 is executed, a record is added to the construction information table 1177. The construction information table 1177 includes an operation application column 771, a server name column 772, a server data I/F column 773, a storage name column 774, a storage data I/F column 775, a logical volume column 776, and a physical disk column 777.

The operation application column 771 stores identifiers uniquely indicating applications of an operation program 3121 used by the physical server 3000. The server name column 772 stores identifiers uniquely identifying the physical server 3000. The server data I/F column 773 stores an identifier uniquely identifying the server data I/F 3200 through which the communication transmitted from the physical server 3000 passes when the physical server 3000 accesses the logical volume 2210 indicated by the logical volume column 775.

The storage name column 774 stores information indicating an identifier of the storage apparatus 2000. The storage data I/F column 775 stores an identifier uniquely identifying the storage data I/F 2600 through which the communication transmitted from the physical server 3000 passes when the physical server 3000 accesses the logical volume 2210 indicated by the logical volume column 776.

The logical volume column 776 stores an identifier uniquely identifying the logical volume 2210. The physical disk column 777 stores an identifier uniquely identifying the physical disk 2220 in which the logical volume 2210 indicated by the logical volume column 776 is created.

The construction information table 1177 stores, as the resources to be passed through, the physical server 3000, the server data I/F 3200, the storage data I/F 2600, the logical volume 2210, and the physical disk 2220, but the construction of the construction information table 1177 of the present invention is not limited to that. For example, the construction information table 1177 of the present invention may store information of identifiers indicating a switch or a switch data I/F and the like.

Moreover, the construction information table 1177 may store information including an identifier indicating the operation program 3110 (DBMS (Data Base Management System) and the like) on the physical server 3000, an identifier indicating a virtual server operating on the physical server 3000 of the server column 772, an identifier indicating the logical server data I/F configured for each virtual server, and the like. The construction information table 1177 illustrated in FIG. 7 includes one path from one physical server 3000 to one physical disk 2220 but may include a plurality of paths from one physical server 3000 to one physical disk 2220.

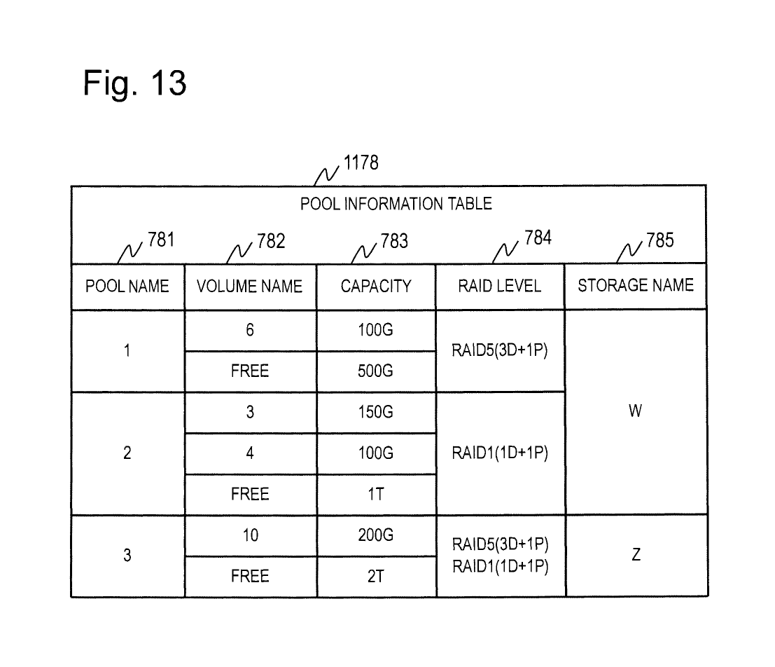

The pool information table 1178 illustrated in FIG. 13 includes information indicating information of free space of each pool in the storage apparatus present in the storage system, information of capacity of each volume which has been created from each pool, and information indicating a RAID level of the pool. When the construction configuration management program 1140 is executed, a record is added to the construction information table 1178. The pool information table 1178 includes a pool name column 781, a volume name column 782, a capacity column 783, an RAID level column 784, and a storage name column 785.

The pool name column 781 stores an identifier indicating a pool which is a data storage region of a volume creating source in the storage apparatus 2000 or across a plurality of the storage apparatuses 2000. The volume name column 782 stores an identifier indicating the logical volume 2210 and the capacity column 783 stores a value indicating a capacity of the logical volume 2210.

Here, if the value stored in the volume name column 782 indicates “free”, the field indicates a data storage region which can be used for addition of a new logical volume, and the size of the data storage region is stored in the capacity column 783.

The RAID level column 784 stores a value indicating availability of the data storage region composing the pool indicated by the pool name 781. For example, if the RAID group has a redundant construction using four physical disks including three data disks and one parity disk, and in which data can be recovered if only one of the physical disks fails, a value of RAIDS (3D+1P) is stored. If the data storage region composing the pool has a plurality of availabilities, the RAID level column 784 stores a plurality of values.

The storage name column 785 stores an identifier of the storage apparatus 2000 which provides a logical volume (storage region) of the volume name column 782.

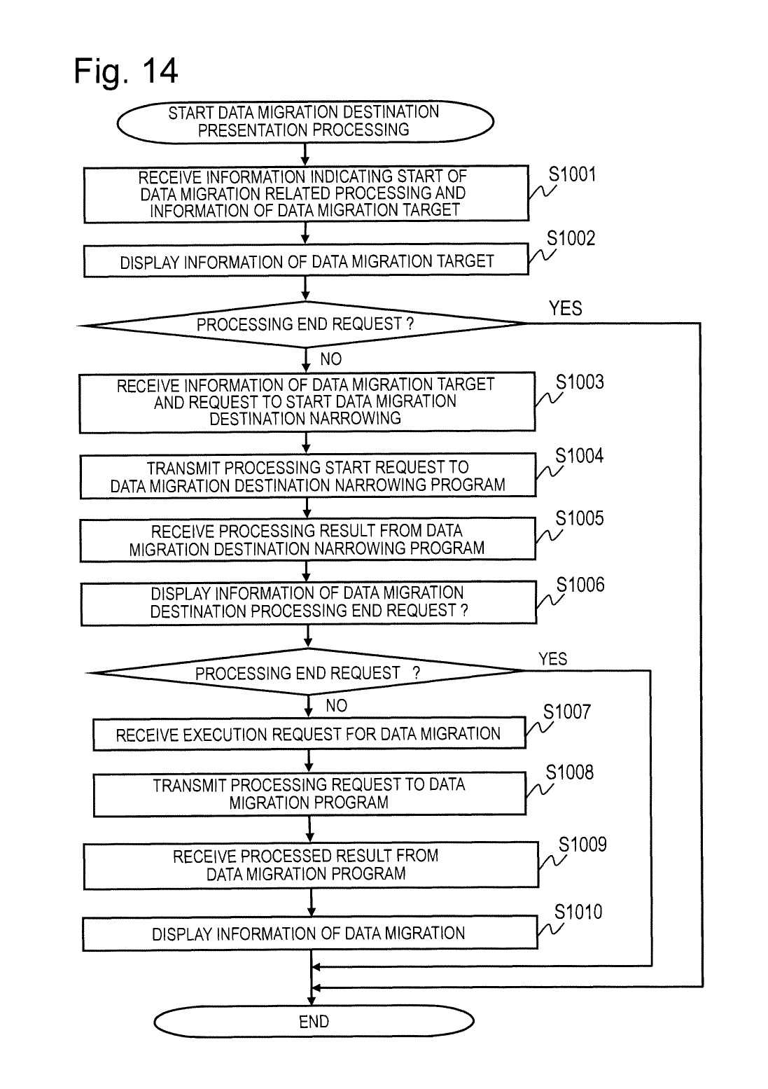

Each management processing executed by the management server 1000 will be described below. FIG. 14 is a flowchart illustrating data migration destination presentation processing by the management server 1000 of the first embodiment of the present invention. The processor 1500 of the management server 1000 executes the data migration destination presentation program 1120 expanded on the memory 1110, whereby the data migration destination presentation processing illustrated in FIG. 14 is executed.

First, the data migration destination presentation program 1120 receives identification information of a migration target together with information indicating that a data migration destination determination will be started through the input device 1300 provided in the management server 1000 (Step S1001). In the following the data migration destination presentation program 1120 receives an input from a user through the input device 1300.

Here, the data migration destination presentation program 1120 displays a configuration start button on the output device 1400 in order to receive the input indicating that the data migration destination determination is to be started or automatically generates an input indicating that the configuration is started when other management programs are to be started. The identification information of the data migration target indicates an identifier indicating a data center of a data migration source or an identifier indicating a storage apparatus of the data migration source.

After Step S1001, the data migration destination presentation program 1120 refers to the construction information table 1177, has a list of the volumes present in the storage apparatus in the received data center outputted by the output device 1400 so as to present it to the user (Step S1002) and waits for an input by the user. In the following, an example in which the output device 1400 is a display will be described. The output device 1400 is not limited to a display but may be a printer or the like.

After Step S1002, the data migration destination presentation program 1120 receives an input indicating that the user has selected the data migration target volume and start narrowing of data migration destination (Step S1003), and then the data migration destination presentation program 1120 transmits a processing start request to the data migration destination narrowing program 1110 (Step S1004).

When the data migration destination narrowing program 1110 has completed data migration destination narrowing processing, the data migration destination presentation program 1120 receives a processing result (Step S1005) and has a list of pools which are candidates for data migration destinations outputted by the output device 1400 by using the received information and the information of the pool information table 1178 so as to present it to the user (Step S1006) and waits for an input by the user.

After Step S1006, when the data migration destination presentation program 1120 receives information indicating that the user has selected start of data migration (Step S1007), the data migration destination presentation program 1120 transmits a processing start request to the data migration program 1130 (Step S1008).

When the data migration program 1130 completes the data migration processing, the data migration destination presentation program 1120 receives a processing result (Step S1009) and has related information of the data migration source and the data migration destination outputted by the output device 1400 so as to present it to the user (Step S1010). If a processing end request is inputted by the user while waiting for the user input in the middle of the step, the data migration destination presentation program 1120 ends the data migration destination presentation processing.

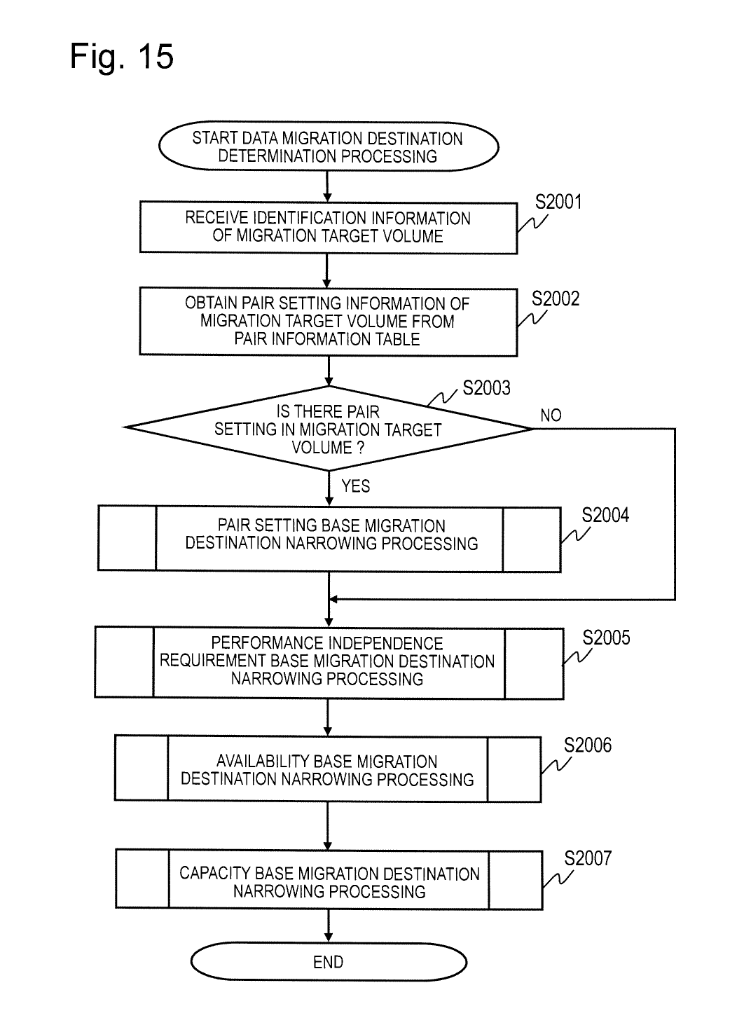

FIG. 15 is a flowchart illustrating data migration destination determination processing by the management server 1000 of the first embodiment of the present invention. The data migration destination determination processing is executed when the processor 1500 of the management server 1000 executes the data migration destination narrowing program 1110 expanded on the memory 1100.

First, the data migration destination narrowing program 1110 receives identification information of the migration target volume from the data migration destination presentation program 1120 (Step S2001). After Step S2001, the data migration destination narrowing program 1110 obtains pair information of the migration target volume form the pair information table 1172 (Step S2002) and determines if there is a pair relationship or not (Step S2003).

If there is a pair relationship (Step S2003: YES), the data migration destination narrowing program 1110 executes pair configuration base migration destination narrowing processing (Step S2004). If there is no pair relationship (Step S2003: NO), the data migration destination narrowing program 1110 skips Step S2004 and proceeds to the subsequent step.

Subsequently, the data migration destination narrowing program 1110 executes narrowing processing on the performance independence requirement basis (Step S2005), executes narrowing processing on the availability basis (Step S2006), and executes narrowing processing on the capacity basis (Step S2007). Each processing will be described in detail.

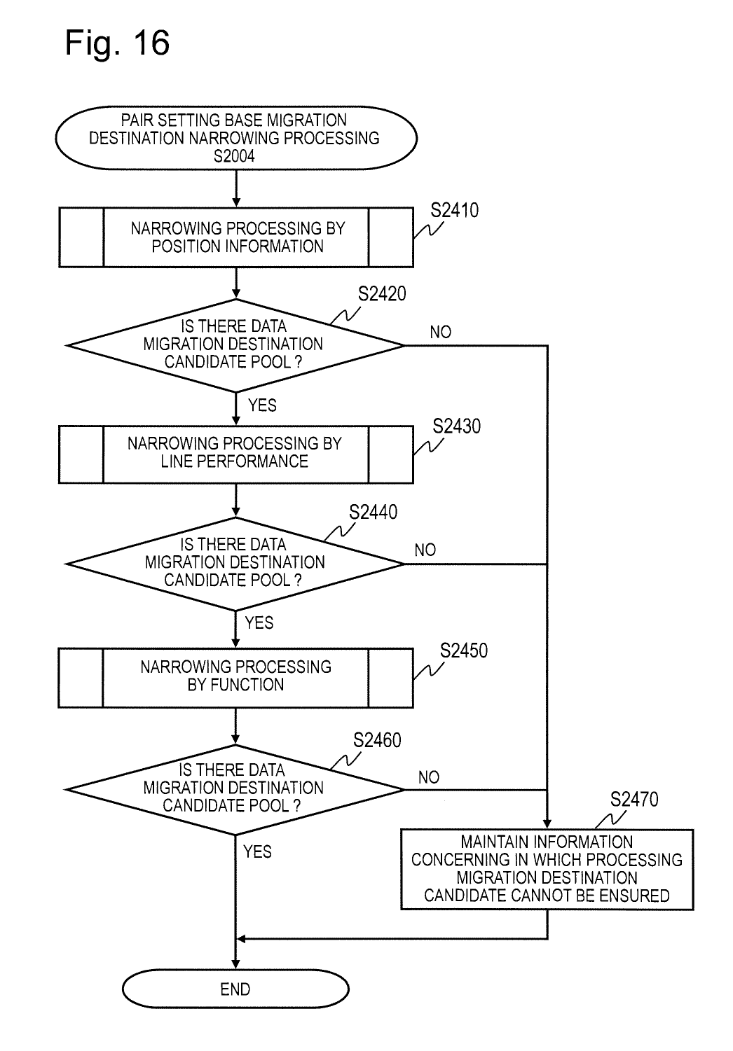

FIG. 16 is a flowchart indicating pair configuration base migration destination narrowing processing (Step S2004), which is a part of the data migration destination determination processing by the management server 1000 of the first embodiment of the present invention. First, the data migration destination narrowing program 1110 executes narrowing processing on the basis of position information (Step S2410) and determines whether or not there is a data migration destination candidate pool (Step S2420).

If there remains a data migration destination candidate (Step S2420: YES), the data migration destination narrowing program 1110 executes narrowing processing on the basis of line performances (Step S2430) and determines again whether or not there is a data migration destination candidate pool (Step S2440).

If there remains a data migration destination candidate (Step S2440: YES), the data migration destination narrowing program 1110 executes narrowing processing on the basis of function (Step S2450) and determines again whether or not there is a data migration destination candidate pool (Step S2460). If there is a data migration destination candidate pool (S2460: YES), the data migration destination narrowing program 1110 ends the migration destination narrowing processing on pair configuration basis.

If it is determined that there is no data migration destination candidate in the middle of the above-described step (Step S2420, S2440 or S2460: NO), the data migration destination narrowing program 1110 holds (stores in the memory 1100) information indicating in which step a migration destination candidate cannot be ensured (Step S2470) and ends the migration destination narrowing processing on pair configuration basis.

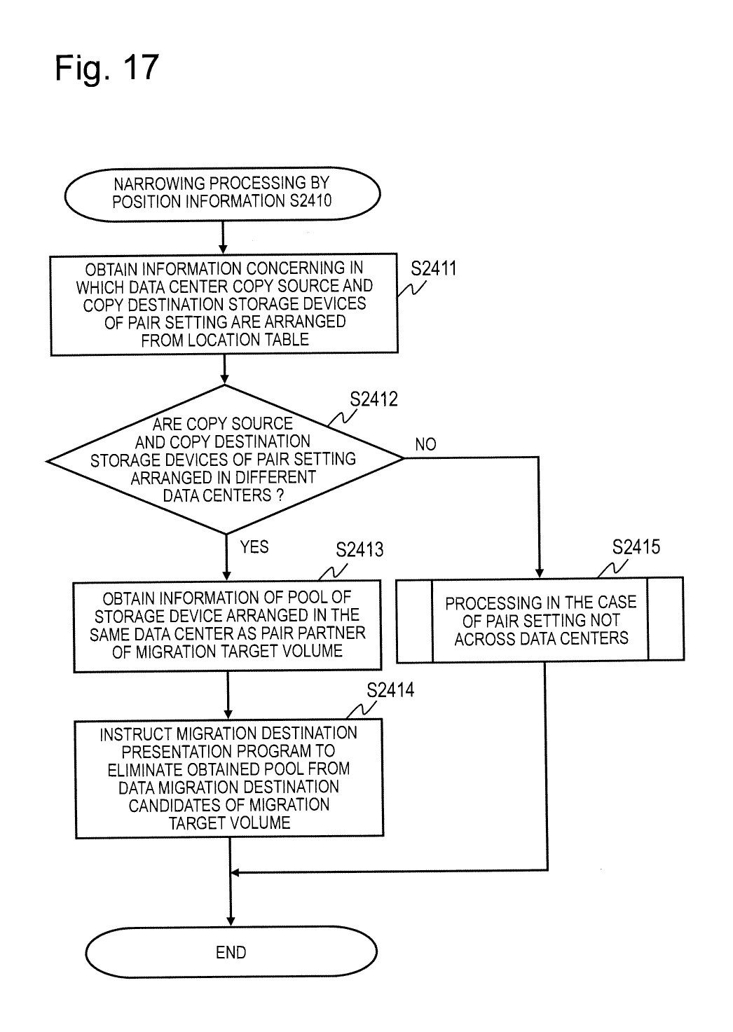

FIG. 17 is a flowchart illustrating narrowing processing on the basis of position information (Step S2410), which is a part of the data migration destination determination processing by the management server 1000 of the first embodiment. First, the data migration destination narrowing program 1110 obtains information on which data center the copy source storage apparatus and the copy destination storage apparatus of the pair configuration are arranged in from the location table 1171 (Step S2411).

Subsequently, the data migration destination narrowing program 1110 determines whether or not the copy source storage apparatus and the copy destination storage apparatus of the pair configuration are arranged in different data centers from the obtained information (Step S2412).

If they are arranged in different data centers (Step S2412: YES), the data migration destination narrowing program 1110 obtains information of the pool of the storage arranged in the same data center as the pair partner of the migration target volume (Step S2413), instructs the migration destination presentation program to eliminate the obtained pool from data migration destination candidates of the migration target volume (Step S2414) and ends the narrowing processing by position information.

On the other hand, if the determination result at Step S2412 shows that they are arranged in the same data center (S2412: NO), the data migration destination narrowing program 1110 executes processing of the pair configuration not across the data centers (Step S2415) and ends the narrowing processing by position information.

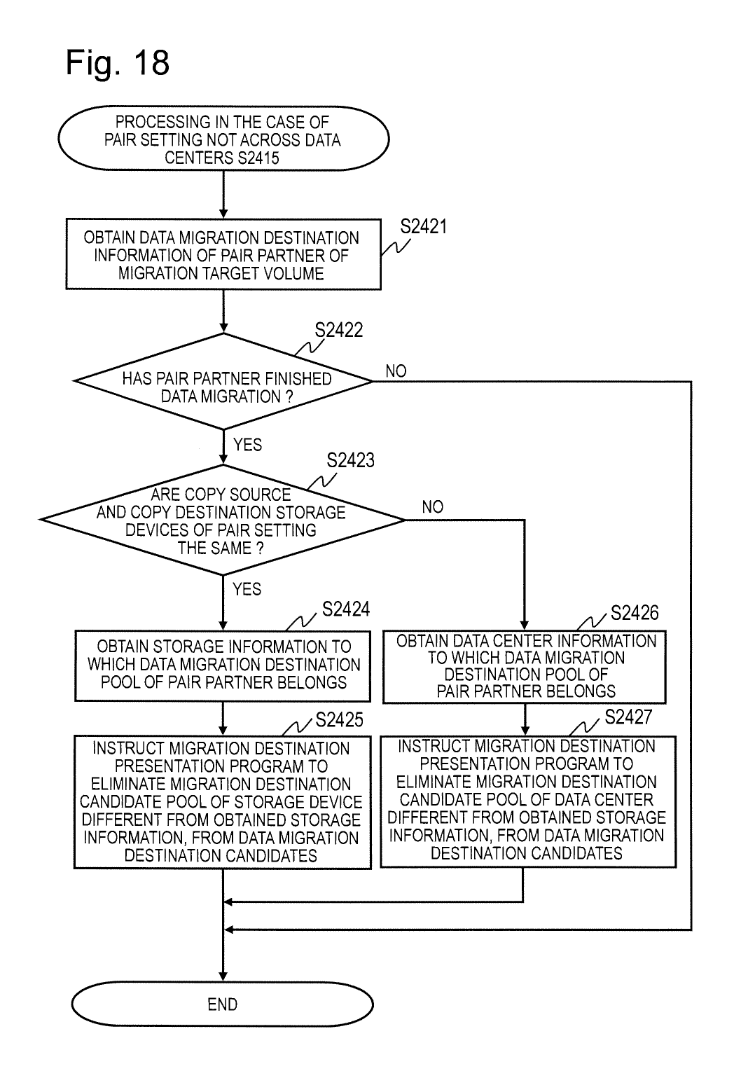

FIG. 18 is a flowchart illustrating processing of the pair configuration not across the data centers (Step S2415), which is a part of the data migration destination determination processing by the management server 1000 of the first embodiment of the present invention. First, the data migration destination narrowing program 1110 obtains the data migration destination information of the pair partner of the migration target volume from the data migration destination presentation program 1120 (Step S2421) and determines whether or not the pair partner has been already migrated from the obtained information (Step S2422).

If the data migration has not been executed for the pair partner (Step S2422: NO), the data migration destination narrowing program 1110 ends the processing of the pair configuration not across the data centers. If the data migration has been executed for the pair partner (Step S2422: YES), the data migration destination narrowing program 1110 proceeds to the subsequent step.

At the subsequent step, the data migration destination narrowing program 1110 determines whether or not the storage apparatus in which the migration target volume is present and the storage apparatus in which the volume of the pair partner is present are the same (Step S2423).

If the volume pair are present in the same storage apparatus in the same data center before the data migration (Step S2423: YES), the data migration destination narrowing program 1110 obtains information of the storage apparatus in which a data migration destination pool of the volume of the pair partner (Step S2424), instructs the migration destination presentation program to eliminate the migration destination candidate pool of the storage apparatus different from the storage apparatus indicated by the obtained information from the data migration destination candidates (Step S2425) and ends the processing of the pair configuration not across the data centers.

If the volume pair is present in the same data center but not in the same storage apparatus before the data migration (Step S2423: NO), the data migration destination narrowing program 1110 obtains information of the data center in which the data migration destination pool of the volume of the pair partner is present (Step S2426), instructs the migration destination presentation program to eliminate the migration destination candidate pool of the data center different from the data center indicated by the obtained information from the data migration destination candidates (Step S2427) and ends the processing of the pair configuration not across the data centers.

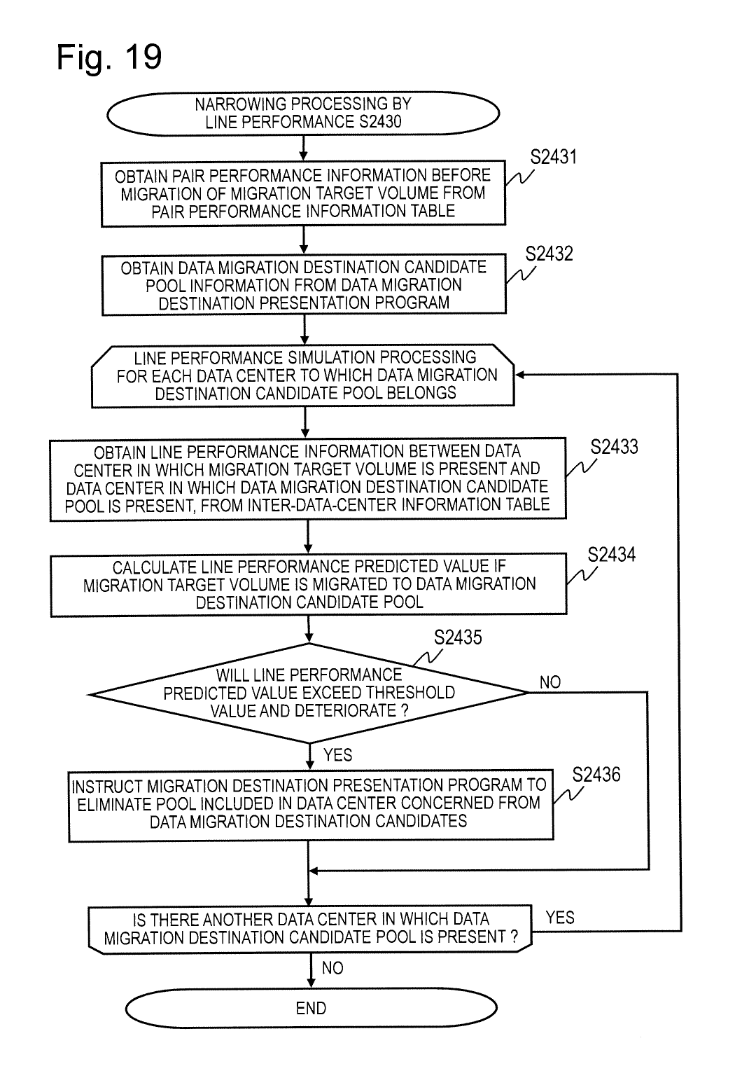

FIG. 19 is a flowchart illustrating narrowing processing on the basis of line performance (Step S2430), which is a part of the data migration destination determination processing by the management server 1000 of the first embodiment of the present invention. First, the data migration destination narrowing program 1110 obtains the pair performance information before data migration of the pair configured for the migration target volume (Step S2431). Subsequently, the data migration destination narrowing program 1110 obtains information of the data migration destination candidate pool remaining as candidate (Step S2432) as the result of narrowing processing by position information (Step S2410).

Subsequently, the data migration destination narrowing program 1110 executes simulation processing to see to what degree the line performances between each data center will be after data migration is executed from Step S2433 to Step S2436 below. First, the data migration destination narrowing program 1110 obtains line performance information between the data center in which the migration target volume is present and the data center in which the data migration destination candidate pool is present from the inter-data-center information table 1174 (Step S2433).

Then, the data migration destination narrowing program 1110 calculates a line performance predicted value if the migration target volume migrates to the data migration destination candidate pool (Step S2434). A calculation method here is that a value obtained at Step S2431 is added to a value obtained at step S2433, but calculation may be made by using other performance indexes such as I/O response time, and any method can be used.

The data migration destination narrowing program 1110 determines whether or not the calculated value shows that the performance will deteriorate beyond a performance threshold value (Step S2435). If the performance will deteriorate (Step S2435: YES), the data migration destination narrowing program 1110 instructs the data migration destination presentation program 1120 to eliminate the pool included in the data center from the data migration destination candidates. If the performance will not deteriorate (Step S2453: NO), Step S2436 is skipped. The data migration destination narrowing program 1110 executes the above-described steps for each combination of the data centers of the copy source and the copy destination and ends the processing.

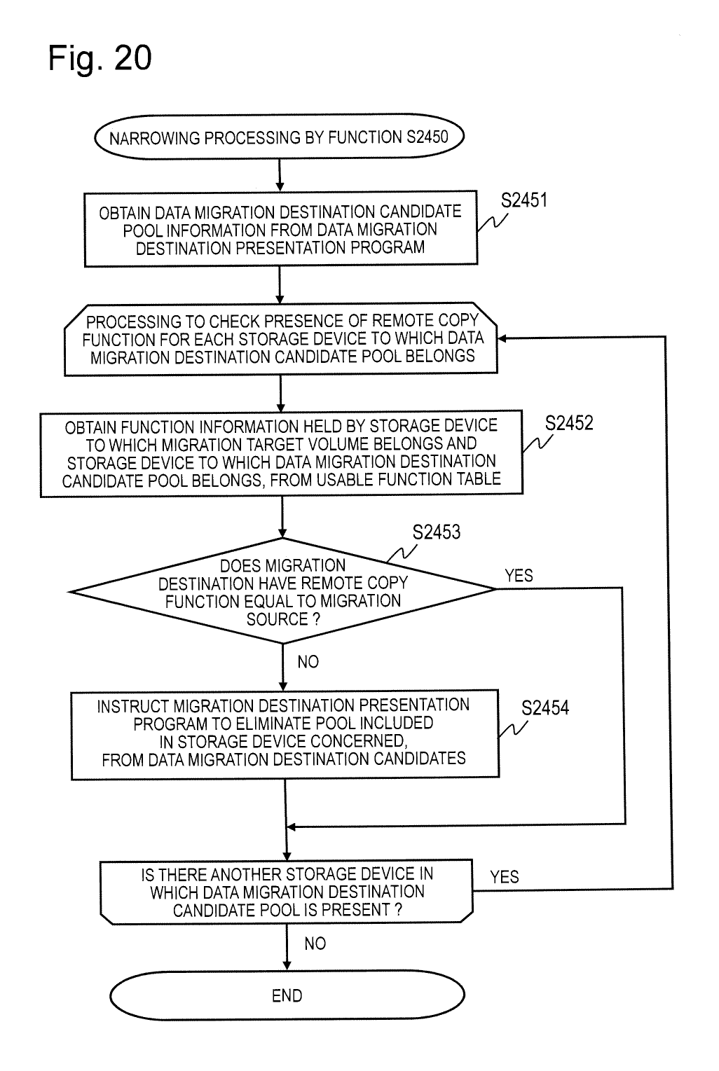

FIG. 20 is a flowchart illustrating narrowing processing by function (Step S2450), which is a part of the data migration destination determination processing by the management server 1000 of the first embodiment of the present invention. First, the data migration destination narrowing program 1110 obtains information of the data migration destination candidate pool remaining as a candidate from the data migration destination presentation program 1120 (Step S2451).

Subsequently, the data migration destination narrowing program 1110 checks whether or not a remote copy function can be used in each storage apparatus to which the pool of the data migration destination candidate belongs from the following Step S2452 to Step S2454. The data migration destination narrowing program 1110 first obtains function information held by the storage apparatus to which the migration target volume belongs or the function information held by the storage apparatus to which the data migration destination candidate pool belongs from the usable function table 1175 (Step S2452).

If the storage apparatus of the data migration source does not has the function equal to that of the storage apparatus of the data migration destination candidate (Step S2453: NO), the data migration destination narrowing program 1110 instructs the data migration destination presentation program 1120 to eliminate the pool included in the storage apparatus from the data migration destination candidates (Step S2454). The data migration destination narrowing program 1110 executes the above-described steps for each storage apparatus in which the data migration destination candidate pool is present and ends the processing.

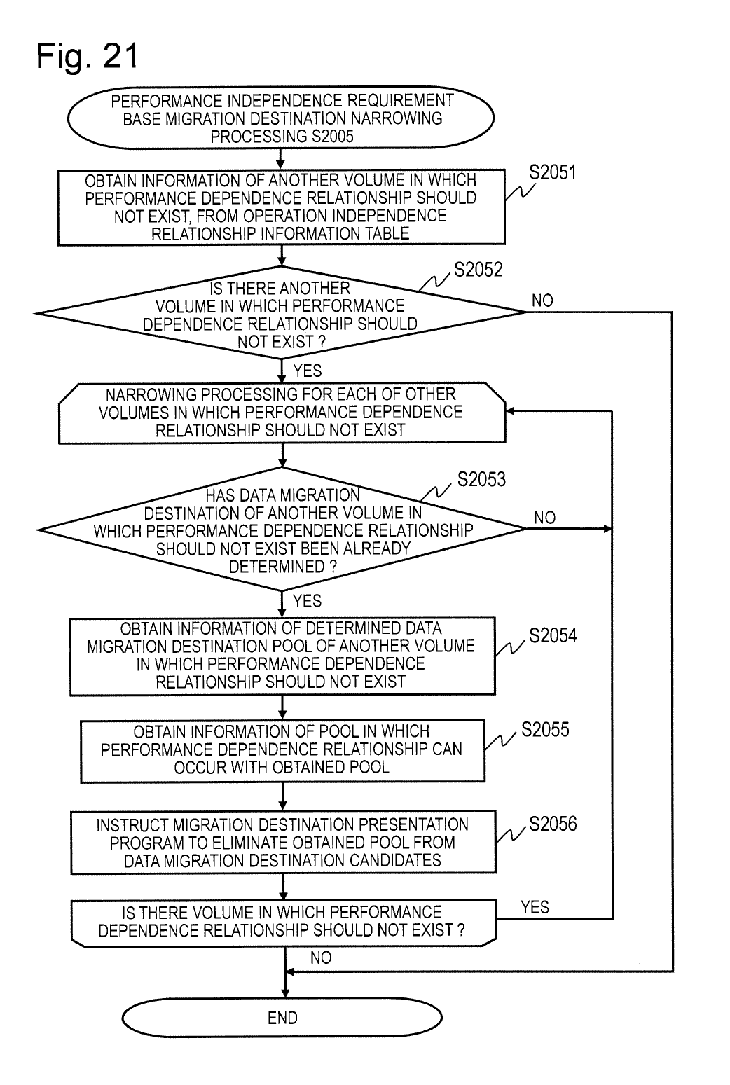

FIG. 21 is a flowchart illustrating migration destination narrowing processing on performance independence requirement basis (Step S2005), which is a part of the data migration destination determination processing by the management server 1000 of the first embodiment of the present invention. First, the data migration destination narrowing program 1110 obtains information of another volume which should not have a performance dependence with the data migration target volume from the operation independence relationship information table 1176 and the construction information table 1177 (Step S2051) and determines whether or not the applicable volume is present (Step S2052).

If there is the applicable volume (Step S2052: YES), the data migration destination narrowing program 1110 executes the following Step S2053 to Step S2056 for each volume. If there is no applicable volume (Step S2052: NO), the following steps are skipped.

The data migration destination narrowing program 1110 determines whether or not the data migration destination of the applicable volume has been already determined (Step S2053). If the data migration destination has been already determined (Step S2053: YES), the data migration destination narrowing program 1110 obtains information of the data migration destination pool (Step S2054).

Subsequently, the data migration destination narrowing program 1110 obtains information of the pool which might have a performance dependence with the data migration destination pool from the pool information table 1178 and the construction information table 1177 (Step S2055).

Here, the pool which might have performance dependence is a pool which shares the same physical disk as the creation source of a physical storage region or a pool which shares the resource on the I/O path to the logical volume created from each. For example, the management server 1000 has a table (information) for managing the physical disk which provides a physical storage region to each pool, and the pool which shares the same physical disk can be identified by referring to the table.

The I/O path is a path from the operation application to the physical disk indicated by the column of the construction information table in FIG. 12. The data migration destination narrowing program 1110 can determine that there is performance dependence by sharing the storage data I/F (meaning sharing of the CPU/memory used by the storage data I/F), for example.

The data migration destination narrowing program 1110 instructs the data migration destination presentation program 1120 to eliminate the pool obtained at Steps S2054 and S2055 from the data migration destination candidates (Step S2056). The data migration destination narrowing program 1110 executes the above-described steps for each volume which should not have performance dependence with the data migration target volume and ends the processing.

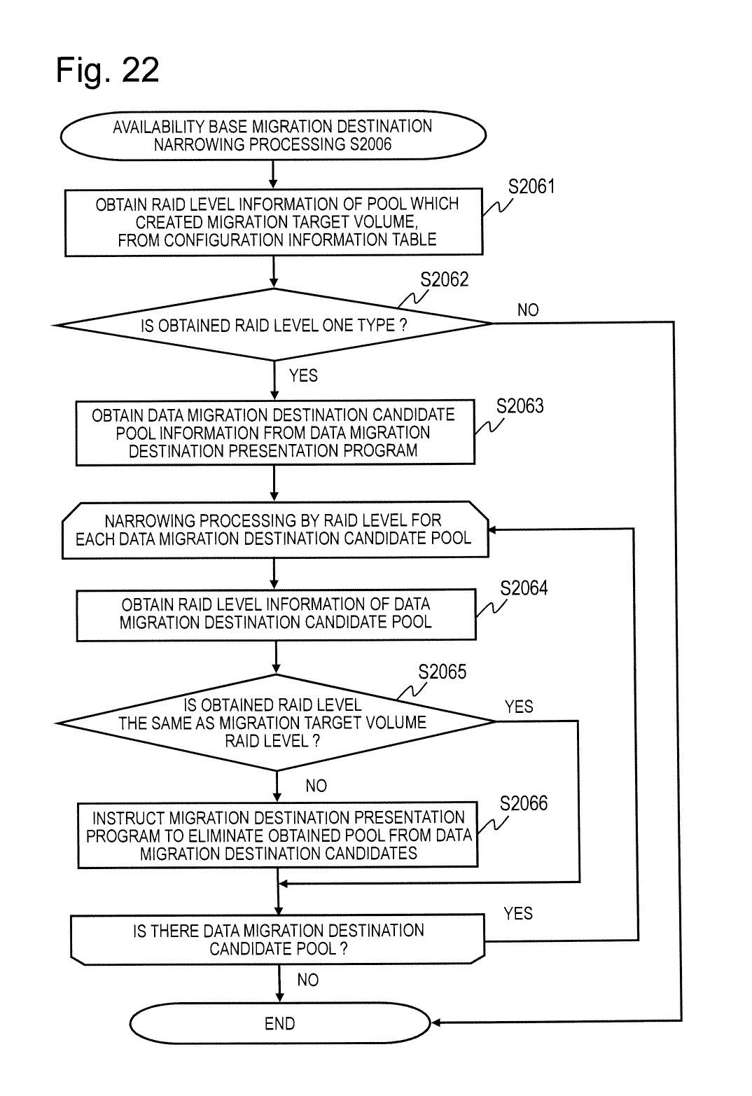

FIG. 22 is a flowchart illustrating availability base migration destination narrowing processing (Step S2006), which is a part of the data migration destination determination processing by the management server 1000 of the first embodiment of the present invention.

First, the data migration destination narrowing program 1110 obtains RAID level information of the pool, which is a creation source of the migration target volume, from the pool information table 1178 (Step S2061). Then, the data migration destination narrowing program 1110 determines whether or not the obtained RAID level is one type, that is, for example, whether or not the pool is comprised of the disc group of one type of availability level (Step S2062).

If the availability level is one type (Step S2062: YES), the data migration destination narrowing program 1110 obtains data migration destination candidate pool information from the data migration destination presentation program 1120 (Step S2063) and executes the processing from the following Step S2064 to Step S2066 for each data migration destination candidate pool. If there are a plurality of availability level types (Step S2062: NO), the data migration destination narrowing program 1110 ends this processing.

First, the data migration destination narrowing program 1110 obtains RAID level information of the data migration destination candidate pool from the pool information table 1178 (Step S2064) and determines whether or not the obtained RAID level is the same as the RAID level of the pool which is a creation source of the migration target volume (Step S2065).

If the obtained RAID level is one type and also the same as the RAID level of the pool which is a creation source of the migration target volume, the determination result at Step S2065 is positive.

If the obtained RAID level is different from the RAID level of the pool which is a creation source of the migration target volume (S2065: NO), the data migration destination narrowing program 1110 instructs the migration destination presentation program to eliminate the pool from the data migration destination candidates (Step S2066). If they are the same (S2065: YES), Step S2066 is skipped. The above-described steps are executed for each data migration destination candidate pool, and the processing is ended.

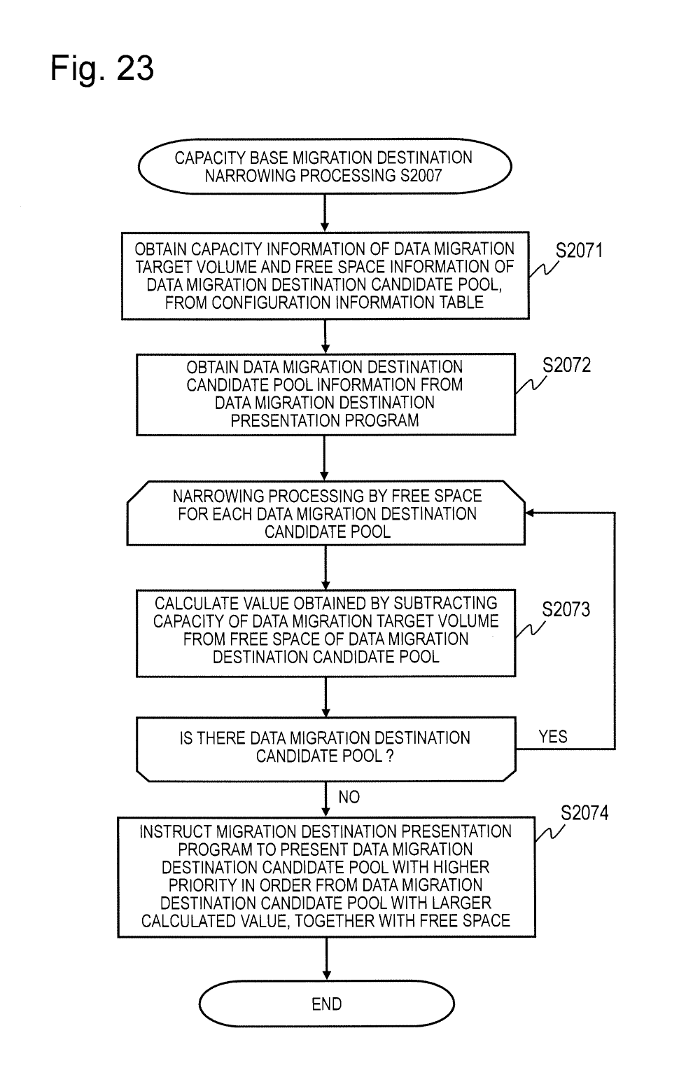

FIG. 23 is a flowchart illustrating capacity base migration destination narrowing processing (Step S2007), which is as part of the data migration destination determination processing by the management server 1000 of the first embodiment of the present invention.

First, the data migration destination narrowing program 1110 obtains capacity information of the migration target volume and free space information of the data migration destination candidate pool (Step S2071). Then, the data migration destination narrowing program 1110 obtains the data migration destination candidate pool information from the data migration destination presentation program 1120 (Step S2072) and calculates a value of remaining free space after movement of the data migration target volume for each data migration destination candidate pool (Step S2073).

The data migration destination narrowing program 1110 instructs the data migration destination presentation program 1120 to present data migration destination candidate pools in order from the pool with a large calculated value as data migration destination candidate pools with high priority together with free spaces (Step S2074) and ends the processing. As described above, the data migration destination narrowing program 1110 is executed.

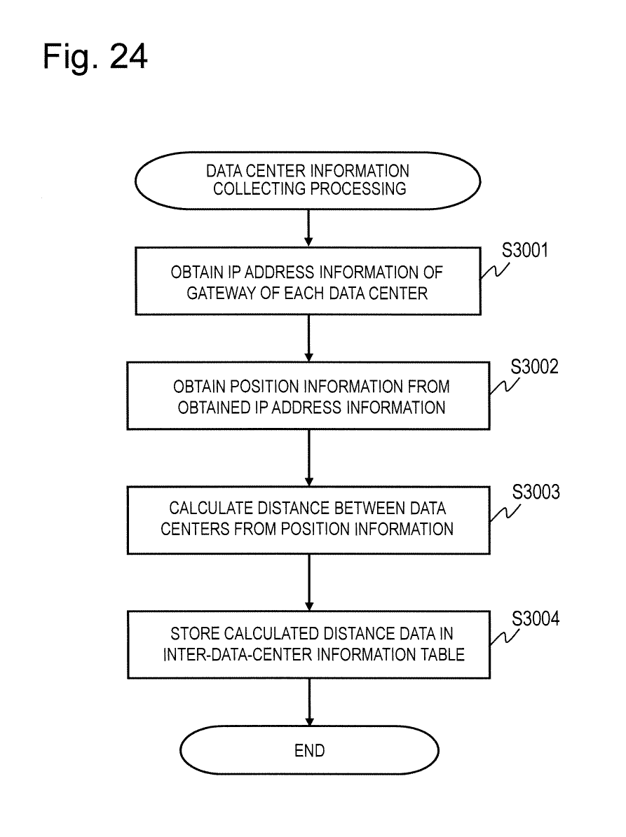

FIG. 24 is a flowchart illustrating data center information collecting processing by the management server 1000 of the first embodiment of the present invention. When the processor 1500 of the management server 1000 executes the data center information collecting program 1160 expanded on the memory 1100, the data center information collecting processing is executed.

First, the data information collecting program 1160 obtains an IP address assigned to the gateway of the data center by a TRACEROUTE command or the like (Step S3001). Then, the data information collecting program 1160 obtains position information from the IP address by using a position information obtaining API provided by a network provider (Step S3002).

A network provider generally associates IP addresses provided for their users with location information of the provider, and it is possible to roughly estimate the current position from the IP address. At present, each provider offers various services, and the data information collecting program 1160 can obtain latitudes/longitudes, country names, city names and the like from the IP address by using the position information obtaining API disclosed by a service provider.

Here, the example in which an IP address is used to obtain position information, but if an apparatus in the data center such as a storage apparatus or a server has a GPS (global positioning system) function, the position information may be obtained by using the GPS information.

Subsequently, the data information collecting program 1160 collects position information of each data center in collaboration with the data information collecting program 1160 of other data centers, calculate a distance between each data center from the position information (Step S3003), and stores the calculated distance information between the data centers in the inter-data-center information table 1174 (Step S3004). The distance information between the data centers does not have to be stored if it is not required for narrowing of migration destination candidates.

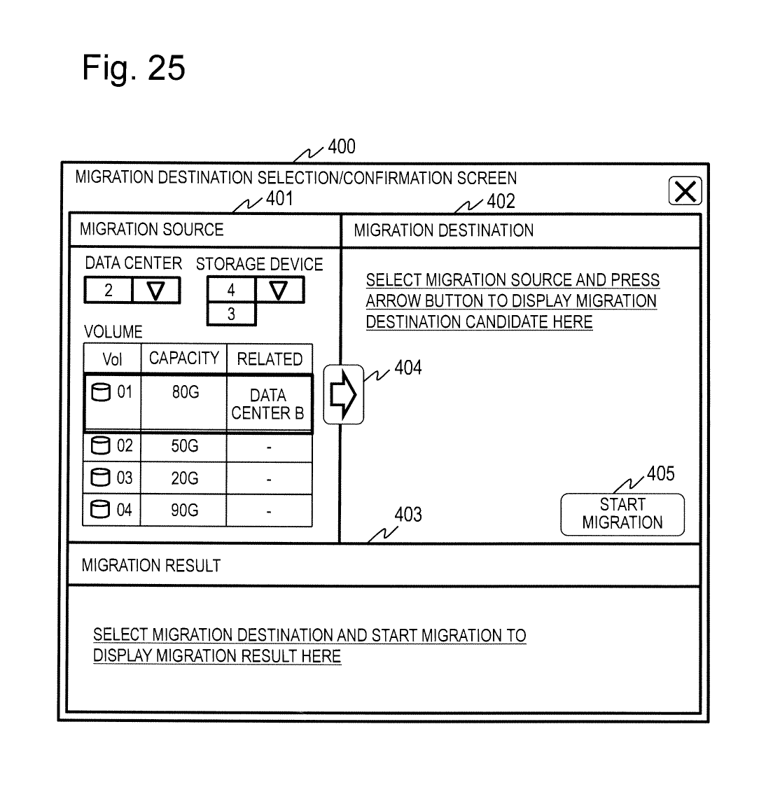

FIGS. 25 to 28 illustrate an example of a data migration destination selection/confirmation screen 400 outputted by executing the data center information collecting program 1120 expanded on the memory 1100. The screen 400 has a migration source region 401 in which information of the data migration target is displayed, a migration destination region 402 in which information of the data migration destination candidate is displayed, and a migration result region 403 in which the migration result is displayed.

FIG. 25 is an example of a display image at Step S1002 of the data migration destination presentation processing illustrated in FIG. 14. The migration source region 401 displays only information of data centers, storage apparatuses, and a volumes but may display other resources indicating the data migration source such as information of a port or a server, and the resources are not limited to those displayed here. Moreover, in this example, only capacity information and related information present in the volume as detailed information of the volume, but other information related to the volume such as performance information of the volume may be displayed, and information to be displayed is not limited to those displayed here.

Since the migration destination narrowing processing/migration processing has not been executed at the stage of Step S1002, the migration destination candidates and migration results are not displayed in the migration destination region 402 and the migration result region 403. The migration destination region 402 and the migration result region 403 in FIG. 25 show an example of displaying a message helping a user operation, but display information is not limited to this example.

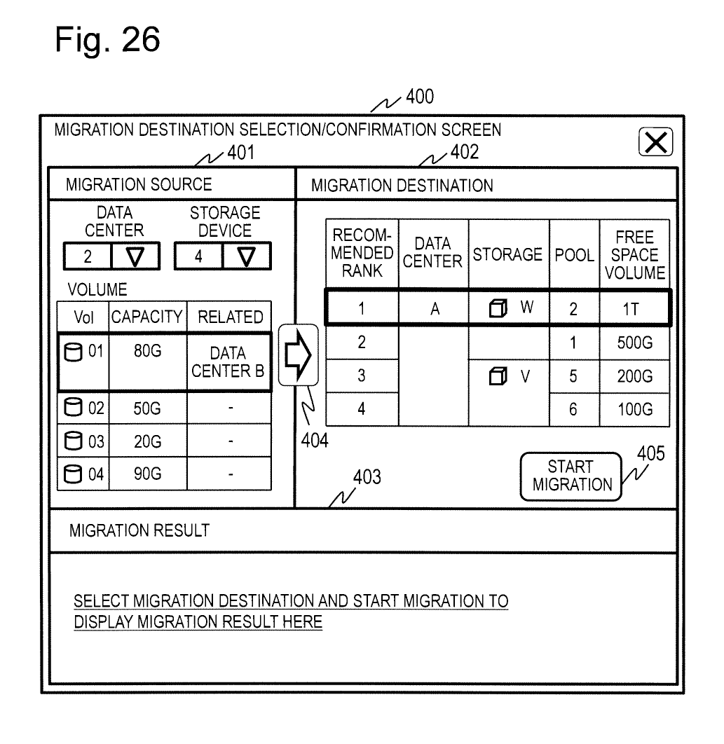

FIG. 26 is an example of a display image at Step S1006 of the data migration destination presentation processing illustrated in FIG. 14. When an administrator selects the migration source volume and presses an arrow button 404 for displaying a migration destination candidate in the image illustrated in FIG. 25, the display image changes to the image illustrated in FIG. 26. The migration destination region 402 displays information of data centers, storage apparatus, pools, and free spaces of the pools as information of the pools, which are migration destination candidates.

Moreover, the migration destination region 402 displays a priority rank (recommended rank) as a data migration destination on the basis of free space information at the same time and displays the ranks in order from the highest. This example displays only free space information as detailed information of the pool, but other information related to the pool such as performance information of the pool may be displayed, and the display information is not limited to this example.

Moreover, the migration destination region 402 may display resources other than the pool, and the display information is not limited to this example. Moreover, this example displays the migration destination candidates according to the priority rank (recommended rank) on the basis of the capacity, but the priority rank may be displayed on the basis of other indexes such as performance or only the migration destination candidate with the highest priority rank may be displayed. The display information is not limited to this example.

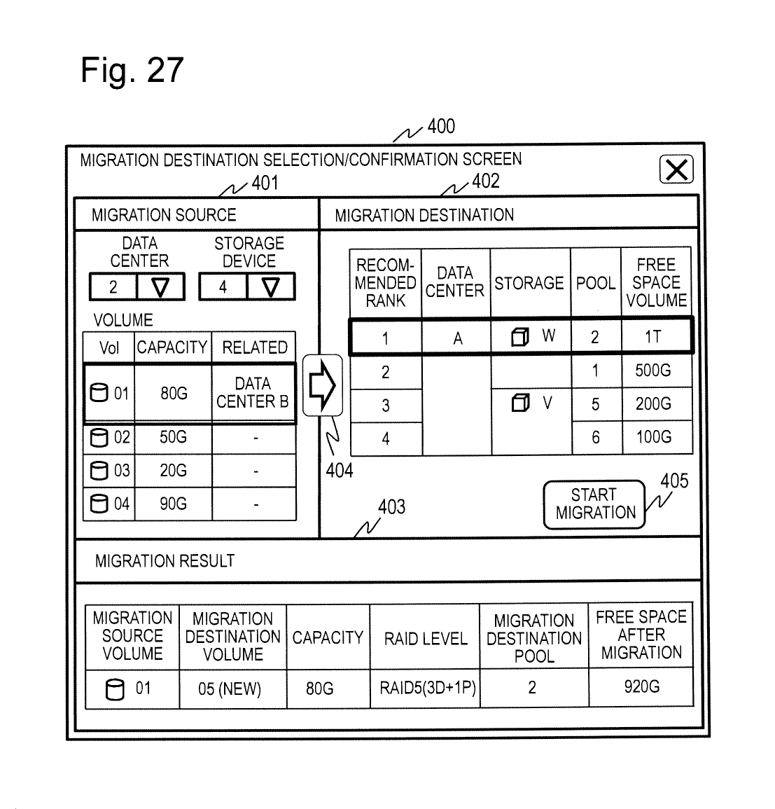

FIG. 27 is an example of a display image at Step S1010 of the data migration destination presentation processing illustrated in FIG. 14. When the administrator selects the migration destination in the image in FIG. 26 and presses a migration start button 405 to execute migration, the display image changes to the image illustrated in FIG. 27.

The migration result region 403 displays a migration source volume, a newly created or selected volume as a migration destination, a capacity of the volume, a RAID level of the volume, a migration destination pool, and free space of the migration destination pool after data migration. The migration result region 403 may display other information related to the volumes of the data migration source and migration destination and other information related to the migration destination pool, and the display information does not have to be limited to this example.

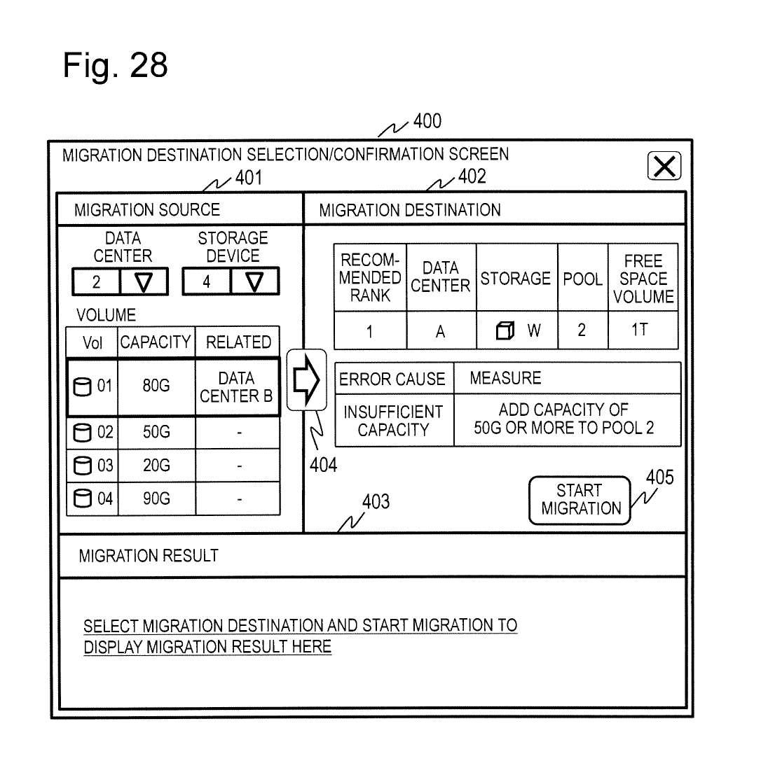

FIG. 28 is another example of the display image at Step S1006 of the data migration destination presentation processing illustrated in FIG. 14. When the administrator selects the migration source volume in the image illustrated in FIG. 25 and presses the arrow button 404 to display the migration destination candidate, the display image changes to the image illustrated in FIG. 28.

The migration destination region 402 displays a fact that an error occurs since there is no pool appropriate as a migration destination and also displays a measure required to bring the migration destination candidate pool with the highest priority rank (recommended rank) into a state appropriate as a migration destination. Here, information of the pool with the highest priority rank as a migration destination candidate, an error cause when the migration destination candidate is selected, and a measure are displayed, but the display information is not limited to this example as in the example in FIG. 26.

According to this embodiment, when data migration is performed, the volume as a data migration target eliminates a candidate not appropriate as a data migration destination in accordance with relevance between the volumes such as disaster recovery and remote backup, so that data migration can be performed keeping the configuration before the data migration meaningful. Moreover, an operation error caused by data migration can be reduced, and a management cost in the data migration can be reduced.

Particularly, according to this embodiment, when data migration is performed, if the volume as a data migration target holds remote copy configuration across the data centers, an operation error caused by data migration can be reduced, and a management cost in the data migration can be reduced by eliminating a data migration destination that cannot maintain the construction across the data centers after the data migration from the data migration destination candidates.

In the above construction, the data migration destination narrowing program 1110 narrows migration destination candidates on a plurality of basis such as the pair configuration basis and the performance independence requirement, but the migration destination candidates may be narrowed only on the basis of a part of them. Moreover, in the pair configuration base narrowing processing, the data migration destination narrowing program 1110 executes the narrowing processing on the basis of the positional information, line performance, and function, but the migration destination candidates may be narrowed on the basis of only a part of them.

In the above constructions example, volumes are created from pools, and they are managed, but as another construction example of this embodiment, volumes may be provided without creating and managing pools. In the above construction example, in the data migration of the volumes of a copy pair of a synchronous or asynchronous remote copy or local copy, the migration destination candidate is determined. The processing in this embodiment can be applied to an arbitrary copy pair in which one of the volumes stores copy data of the other volume.

For example, the above processing can be applied to a copy pair of an original volume and its backup volume or a copy pair of an original volume and a volume storing its snapshot.

As illustrated in FIG. 14, in the above example, one or more migration destination candidates are presented, and the data is moved to the migration destination selected by the user, but in the system of this embodiment, a storage apparatus of a migration destination may be automatically determined without receiving a selection by the user and moreover, the data may be moved to the migration destination. For example, the system may select an arbitrary storage apparatus selected from the migration destination candidates without selecting a migration destination candidate with the highest priority as a migration destination or without using priority.

The system of this embodiment may use position information different from the position information indicating the data center in narrowing of a migration destination candidate by position information. The position information may indicate an area in which the storage apparatus is installed (a city or a town, for example) or may indicate latitude and longitude.

For example, the system may execute narrowing processing on the basis of position information by using position information from a network address or GPS of the storage apparatus. The system specifies an area in which the storage apparatus is installed from the IP address of the storage apparatus and if two storage apparatuses before migration are installed in the same area, for example, the system narrows migration destination candidates so that the two storage apparatuses after migration are located in the same area.

The system can specify the distance between the storage apparatuses before data migration and the distance between the storage apparatuses after the data migration from the information by GPS. For example, the system selects a migration destination candidate so that the distance after the data migration becomes not less than or not more than the distance before the data migration or a difference between the distance after the data migration and the distance before the data migration becomes smaller than a threshold value.

### Second Embodiment

A second embodiment of the present invention will be described. In the following description, a difference from the first embodiment of the present invention will be mainly described, and the description duplicated with that of the first embodiment will be omitted as appropriate.

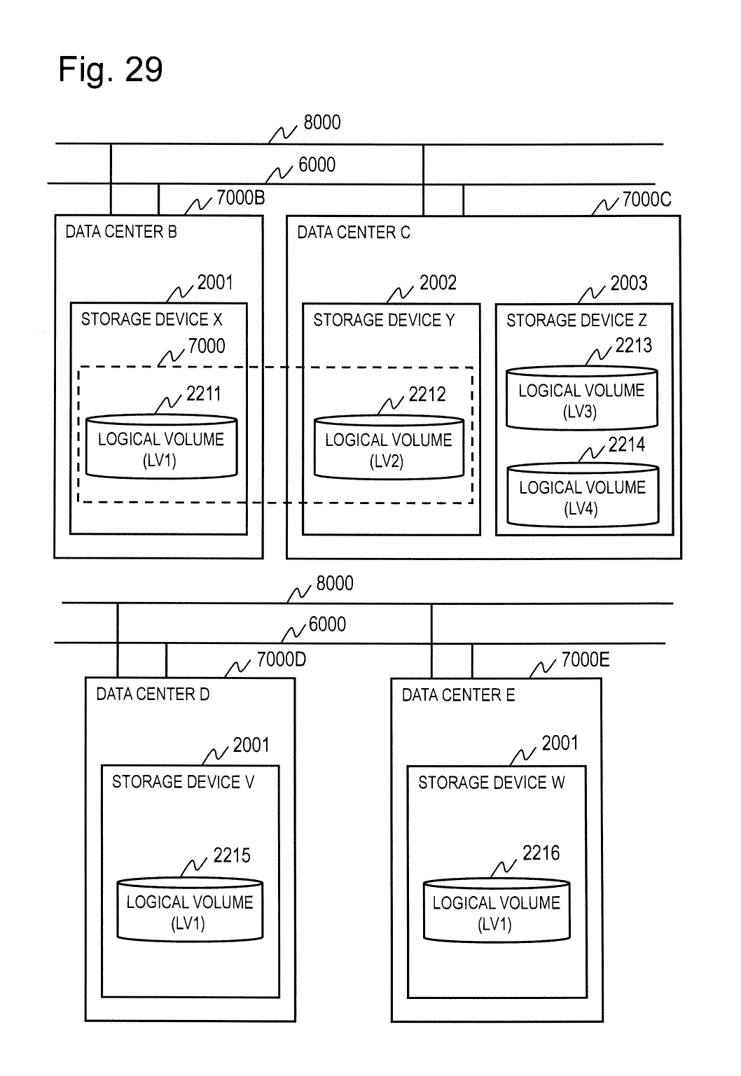

FIG. 29 is a block diagram illustrating a logical construction of the case across the data centers in the second embodiment of the present invention. A pair relationship of synchronous remote copies (the copy pair 7000) is configured between the logical volume 2211 (LV1) in the storage apparatus 2001 (storage apparatus X) arranged in the data center 7000B and the logical volume 2212 (LV2) in the storage apparatus 2002 (storage apparatus Y) arranged in the data center 7000C.

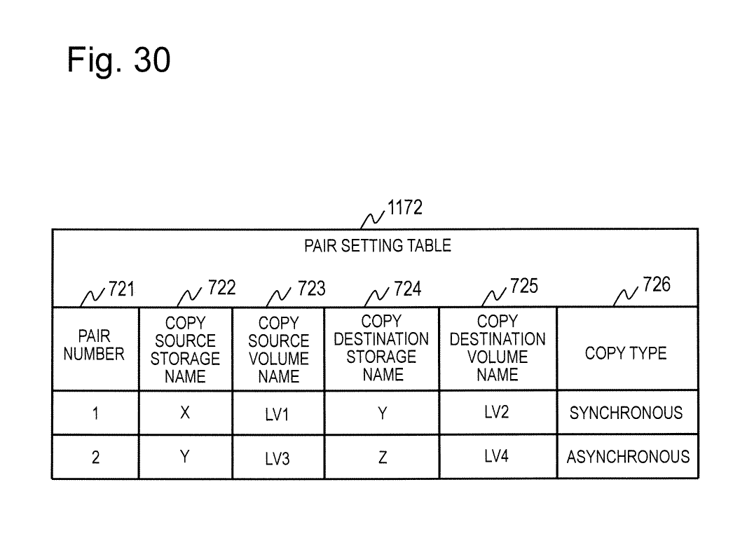

FIG. 30 illustrates an example of the pair configuration table 1172 of the second embodiment of the present invention. The pair configuration table 1172 includes information indicating a pair relationship having been configured in the storage system. The construction configuration management program 1140 collects information of the copy pair in collaboration with the construction performance information collecting program 2120 of the storage apparatus and the construction configuration management programs 1140 in the other data centers and adds a record to the pair configuration table 1172.

The pair configuration table 1172 includes the pair number column 721, the copy source storage name column 722, the copy source volume name column 723, the copy destination storage name column 724, the copy destination volume name column 725, and the copy type column 726. The pair number column 721 stores identifiers indicating pairs, the copy source storage name column 722 stores identifiers of storage apparatuses which are copy sources of the pairs, and the copy source volume name column 723 stores identifiers of the volumes which are copy sources.

The copy destination storage name column 724 stores identifiers of the storage apparatuses which are copy destinations of the pairs, the copy destination volume name column 725 stores identifiers of the volumes which are copy destinations of the pairs, and the copy type column 726 stores information indicating whether the copy pair is a synchronous copy or an asynchronous copy.

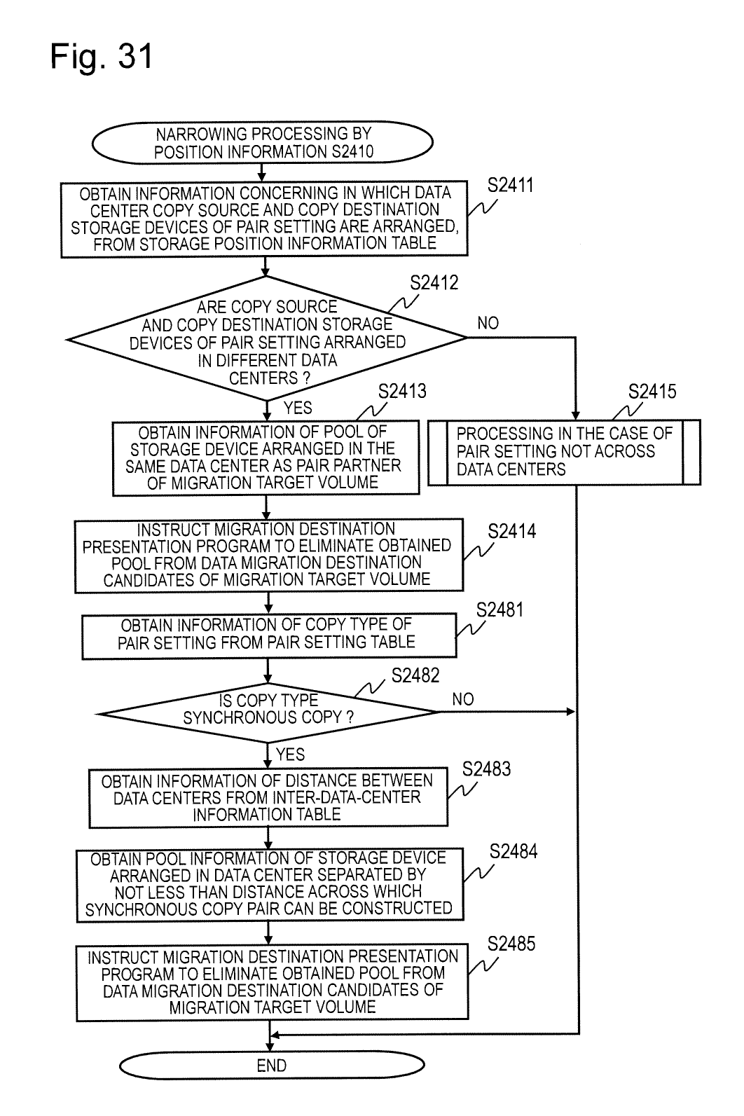

FIG. 31 is a flowchart illustrating the narrowing processing (Step S2410) on the basis of position information, which is a part of the data migration destination determination processing of this embodiment. Since processing from Step S2411 to Step S2415 is the same as the narrowing processing on the basis of position information (See FIG. 17) in the first embodiment, the description will be omitted.

At Step S2481, the data migration destination narrowing program 1110 obtains information on whether the copy type is synchronous copy or asynchronous copy from the pair configuration table 1172. Subsequently, the data migration destination narrowing program 1110 determines whether or not the copy type is synchronous copy (Step S2482).

In the case of the asynchronous copy (Step S2482: NO), the data migration destination narrowing program 1110 finishes this processing. In the case of synchronous copy (Step S2482: YES), the data migration destination narrowing program 1110 ends this processing. In the case of the synchronous copy (Step S2483: YES), the data migration destination narrowing program 1110 obtains information of distance between the data centers from the inter-data-center information table 1174 (Step S2483).

The data migration destination narrowing program 1110 searches the data center separated by more than a distance across which the synchronous copy pair can be constructed from the obtained distance information and obtains the information of a storage pool arranged in such data center from the location table 1171 and the pool information table 1178 (Step S2484).

Subsequently, the data migration destination narrowing program 1110 instructs the migration destination presentation program to eliminate the obtained pool from the data migration destination candidates of the migration target volumes (Step S2485) and finishes the processing. For example, suppose that the inter-data-center distance between the data centers D and C is 1000 km, and the inter-data-center distance between the data centers E and C is 50 km. The data migration destination narrowing program 1110 eliminates the pool in the data center D which is the migration destination outside the range within which the construction of the synchronous copy can be maintained from the data migration destinations of the logical volumes LV1 of the storage apparatus X2001.

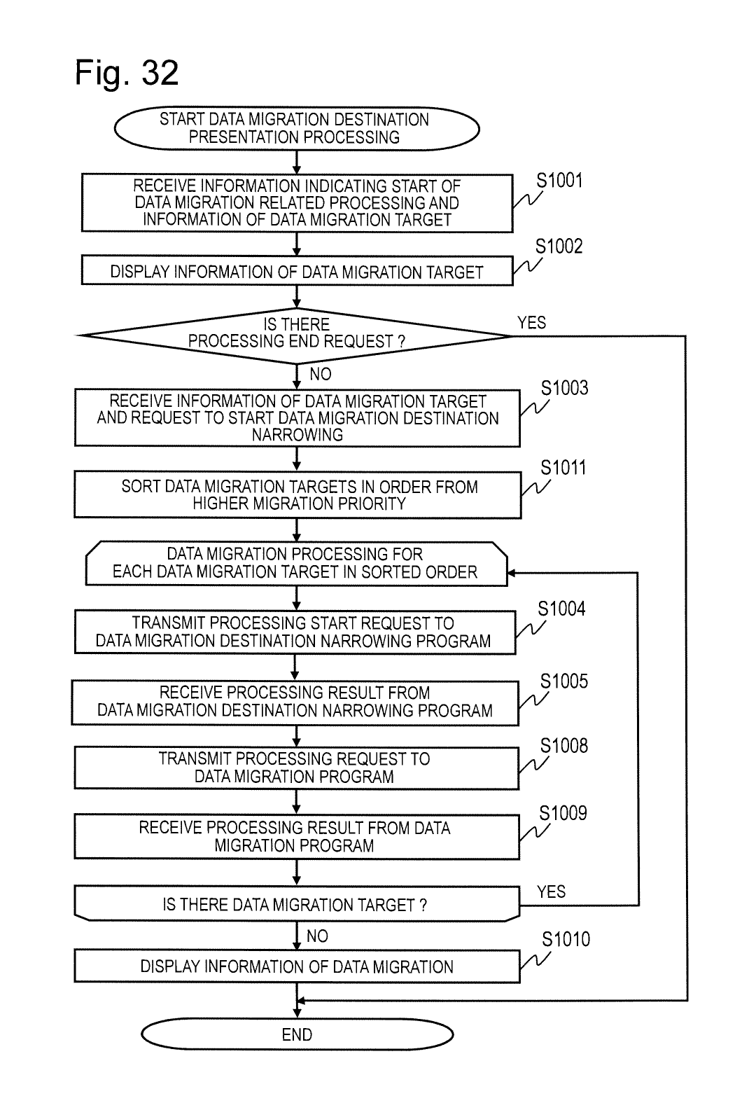

FIG. 32 is a flowchart illustrating the data migration destination presentation processing of this embodiment. First, the data migration destination presentation program 1120 receives the identification information of the migration target together with the information indicating start of the data migration destination determination through the input device 1300 provided in the management server 1000 (Step S1001). In the following the data migration destination presentation program 1120 receives an input from the user through the input device 1300.

The data migration destination presentation program 1120 displays a configuration start button on the output device 1400 in order to receive an input indicating start of the data migration destination determination or automatically generate an input indicating start of configuration when other management programs are started. The identification information of the data migration target indicates an identifier indicating the data center of the data migration source or an identifier indicating the storage of the data migration source.

After Step S1001, the data migration destination presentation program 1120 refers to the construction information table 1177, has a list of volumes present in the storage apparatus in the received data center outputted by the output device 1400 so as to present it to the user (Step S1002), and waits for an input from the user. In the following, an example in which the output device 1400 is a display will be described. The output device 1400 is not limited to the display but may be a printer or the like.

After Step S1002, when the data migration destination presentation program 1120 receives an input indicating that the user has selected the data migration target volume and start of the data migration destination narrowing (Step S1003), the data migration targets are rearranged in the order from the highest migration priority (recommendation) (Step S1011), and data migration processing is executed for each data migration target in that rearranged order (Steps S1004, S1005, S1008, S1009).

Specifically, the data migration destination presentation program 1120 first transmits a processing start request to the data migration destination narrowing program 1110 (Step S1004). When the data migration destination narrowing program 1110 completes the data migration destination narrowing processing, the data migration destination presentation program 1120 receives the processing result (Step S1005).

The data migration destination presentation program 1020 transmits a processing start request to the data migration program 1130 (Step S1008). When the data migration program 1130 completes the data migration processing, the data migration destination presentation program 1120 receives the processing result (Step S1009).

After the above-described processing has been executed and completed for all the data migration targets, the data migration destination presentation program 1120 uses the received information to have the related information of the data migration source and the data migration destination outputted by the output device 1400 so as to present it to the administrator (user) (Step S1010).

An output image presented to the user may be similar to that illustrated in the migration result region 403 in FIG. 27. It shows the relation of all the migration source volumes and the migration destination volumes of the migration targets. The output image may be of any type as long as the results of the completed data migration can be indicated and does not have to be limited to this example. It may be so configured that the data migration destination targets are presented before the data migration and selected by the administrator (user) and then, processing of data migration is executed as in the data migration destination processing illustrated in FIG. 14 in the first embodiment.

In the computer system of this embodiment, when data is to be migrated, the data migration destinations that can no longer maintain the construction with a distance across the data centers which can operate as synchronous copies without a problem after the data migration are eliminated from the data migration destination candidates if the volumes of the data migration targets maintain remote copy configuration or particularly synchronous copy configuration across the data centers, so that an operation error caused by the data migration is reduced, and a management cost in the data migration can be reduced.

### Third Embodiment

A third embodiment of the present invention will be described. In the following description, a difference from the first embodiment of the present invention will be mainly described, and the description duplicated with that of the first embodiment will be omitted as appropriate.

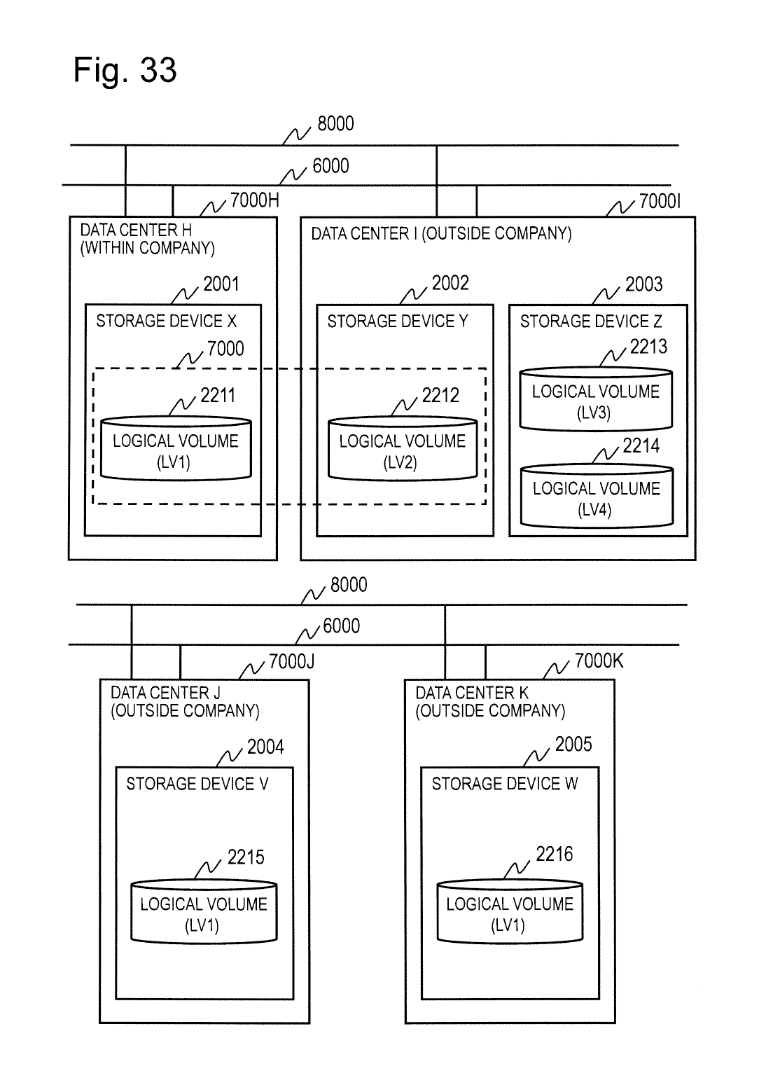

FIG. 33 is a block diagram illustrating a logical construction of the case across the data centers in the third embodiment of the present invention. A pair relationship of synchronous remote copies (the copy pair 7000) is configured between the logical volume 2211 (LV1) in the storage apparatus 2001 (storage apparatus x) arranged in the data center 7000H and the logical volume 2212 (LV2) in the storage apparatus 2002 (storage apparatus Y) arranged in the data center 70001.

Here, the data center H (7000H) is supposed to be a data center within the company, while the data center I (7000I), the data center J (7000J), and the data center K (7000K) are supposed to be data centers outside the company.

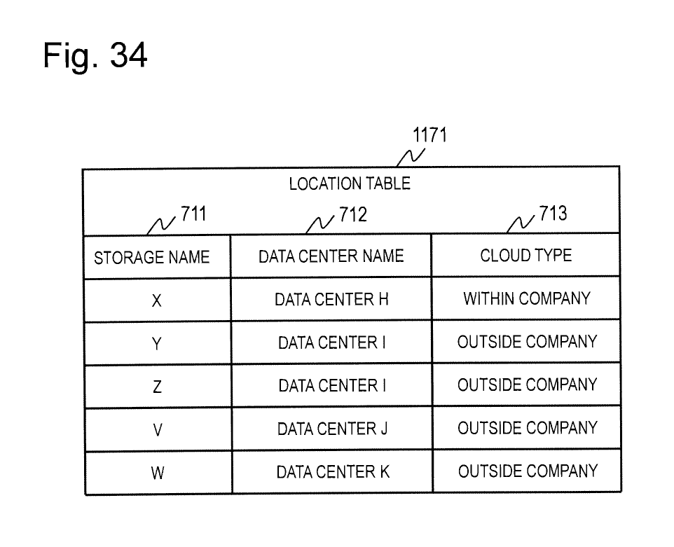

FIG. 34 illustrates an example of the location table 1171 of the third embodiment of the present invention. The location table 1171 includes information indicating the storage apparatuses present in the computer system and the correspondence relationships on which data center the storage apparatus is arranged in. When the position information obtaining processing of the data center information collecting program 1160 is executed, information is added to the location table 1171.

The location table 1171 includes the storage name column 711, the data center name column 712, and a cloud type column 713. The storage name column 711 stores identifiers indicating the storage apparatuses, and the data center name column 712 stores identifiers indicating the data centers. The cloud type column 713 stores information indicating whether the data center is a data center within the company or a data center outside the company.

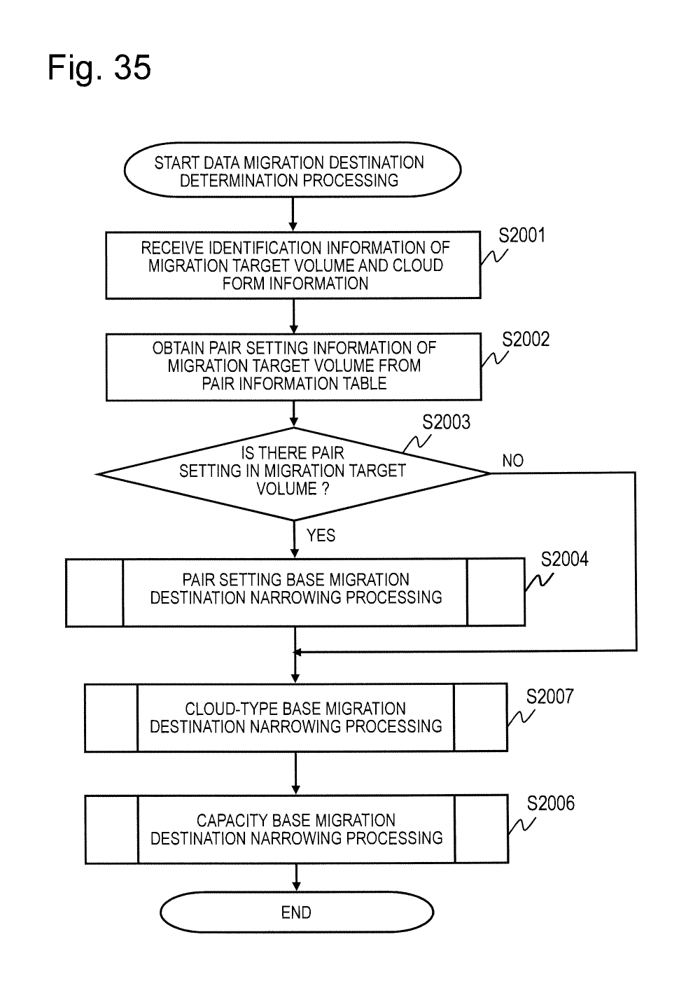

FIG. 35 is a flowchart illustrating the data migration destination determination processing of this embodiment. This flow executes the migration destination narrowing processing (Step S2007) on the cloud form basis as a difference from the data migration destination determination processing in the first embodiment.

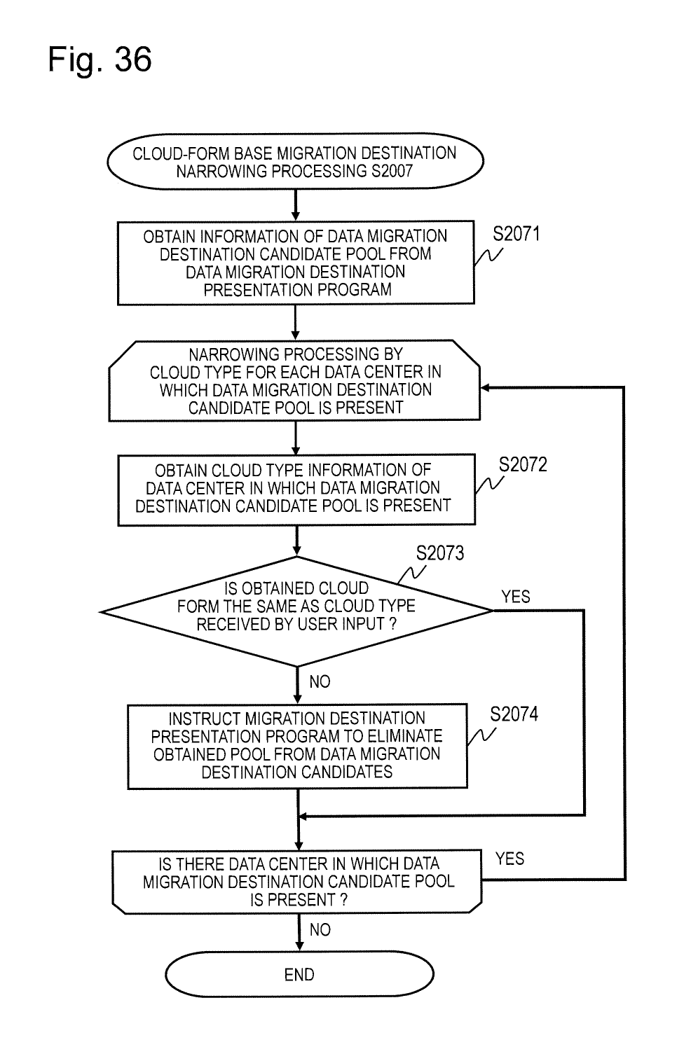

FIG. 36 illustrates a flowchart in the migration destination narrowing processing on the cloud form basis. The data migration destination narrowing program 1110 obtains a cloud type of each data center from the location table 1171. In FIG. 36, the data migration destination narrowing program 1110 obtains information of the data migration destination candidate pools from the data migration destination presentation program 1120 (Step S2071). Subsequently, the narrowing processing is executed by the cloud type from Step S2071 to Step S2-74 for each data center present in the data migration destination candidate pool.

The cloud type of the data center in which the data migration destination candidate pool is present is obtained from the position information table (Step S2071), it is determined whether or not the obtained cloud type is the same as the cloud form received by the user input (Step S2073), and if they are not the same, an instruction is given to the migration destination presentation program to eliminate the pool in the data center from the data migration destination candidates (Step S2074). The above-described processing is executed for all the data centers in which the data migration destination candidate pool and the processing is finished.

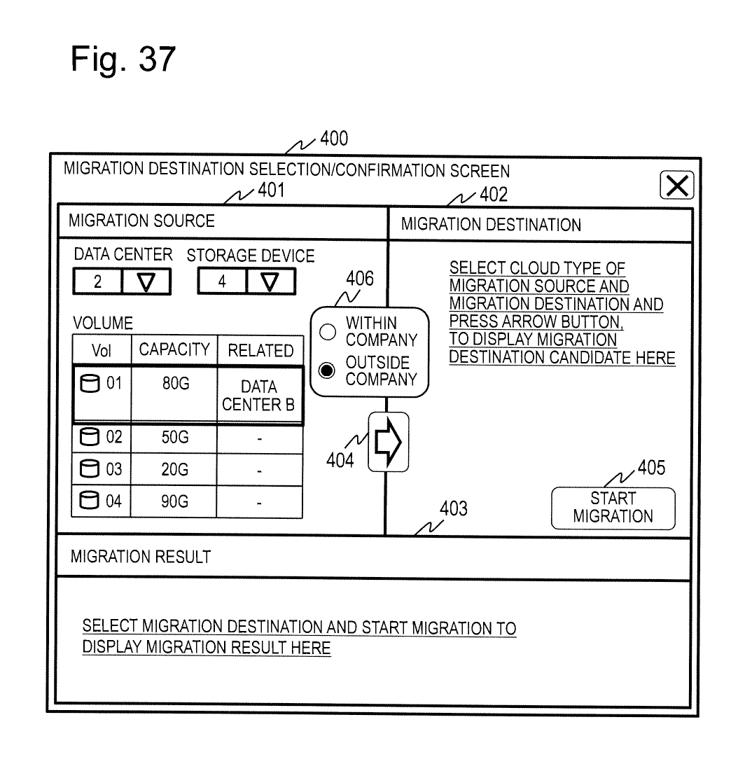

FIG. 37 is an example of a display image at Step S1006 of the data migration destination presentation processing. In FIG. 37, the administrator (user) selects a selection button 406 indicating the migration source volume and which cloud type data center to migrate. After that, when the administrator (user) presses the arrow button 404 for displaying the migration destination candidate and the migration start button 405, the display image changes to the screen illustrated in FIG. 26. Here, the displayed information may be such that the migration destination region 402 displays the cloud type information and does not have to limit this example.

In the computer system of this embodiment, when data is to be migrated, if the volumes of the data migration targets maintain remote copy configuration across the data centers, only a data migration destination across the data centers and having a cloud type desired by the user after the data migration can be selected as the data migration destination candidate so that an operation error caused by the data migration is reduced, and a management cost in the data migration can be reduced.

The present invention has been described in the above in details by referring to the attached drawings, but the present invention is not limited to these specific constructions but includes various changes and equal constructions within the gist of the scope of the appended claims.

What is claimed is:

1. A management system managing an information storage system including a plurality of storage apparatuses, the management system comprising:
a memory apparatus; and
a processor,
wherein the memory apparatus stores position management information indicating an installation position of each of the plurality of storage apparatuses,
wherein the processor specifies a position of a first storage apparatus including a first volume and a position of a second storage apparatus including a second volume composing a copy pair with the first volume from the position management information,
wherein the processor determines a positional relationship between the first storage apparatus and the second storage apparatus before data migration from the specified position of the first storage apparatus and the specified position of the second storage apparatus,
wherein, in a case where the second volume is not to be migrated, the processor determines a condition of a positional relationship after the data migration to be satisfied between a migration destination storage apparatus of data of the first volume and the second storage apparatus based on the positional relationship before the data migration, and
wherein the processor selects a storage apparatus which satisfies at least the condition of positional relationship after the data migration from the plurality of storage apparatuses as a candidate of the migration destination storage apparatus.

2. A management system according to claim 1,
wherein the position management information indicates that the first storage apparatus and the second storage apparatus are installed at different positions, and
wherein the condition of positional relationship after the data migration indicates that the migration destination storage apparatus is installed at a position different from the position of the second storage apparatus.

3. A management system according to claim 2,
wherein the position management information includes identification information of a facility in which each of the plurality of storage apparatuses is present as information indicating the installation position of each of the plurality of storage apparatuses,
wherein the position management information indicates that the first storage apparatus and the second storage apparatus are installed at different facilities, and
wherein the condition of positional relationship after the data migration indicates that the migration destination storage apparatus is present in a facility different from the facility of the second storage apparatus.

4. A management system according to claim 1,
wherein the processor determines a second condition of positional relationship after the data migration to be satisfied between the migration destination storage apparatus of the data of the first volume and a third storage apparatus based on the positional relationship before the data migration in a case where the second volume is to be migrated to the third storage apparatus, and
wherein the processor selects a storage apparatus which satisfies at least the second condition of positional relationship after the data migration from the plurality of storage apparatuses as a candidate of the migration destination storage.

5. A management system according to claim 1,
wherein the position management information includes a network address of each of the plurality of storage apparatuses, and
wherein the processor determines the positional relationship before the data migration from a network address of the first storage apparatus and a network address of the second storage apparatus.

6. A management system according to claim 1,
wherein the first volume and the second volume are a copy pair of synchronous remote copy, and
wherein the condition of positional relationship after the data migration indicates that a distance between the second storage apparatus and the migration destination storage apparatus is shorter than a threshold value.

7. A management system according to claim 1,
wherein the processor determines line performance to be satisfied between the second storage apparatus and the migration destination storage apparatus based on data transfer performance between the first volume and the second volume, and
wherein the candidate of the migration destination storage apparatus selected by the processor satisfies the determined line performance between the second storage apparatus and the migration destination storage apparatus.

8. A management system according to claim 1,
wherein the management system includes an output device and an input device,
wherein the output device outputs a plurality of migration destination storage apparatus candidates, and
wherein the processor determines the migration destination storage apparatus candidate selected by the input device as the migration destination storage apparatus of the data of the first volume.

9. A management system according to claim 1,
wherein the memory apparatus stores performance independence relationship management information which specifies a volume designated to satisfy a performance independence relationship with respect to the first volume, and
wherein the processor refers to the performance independence relationship management information to select the candidate of the migration destination storage apparatus from storage apparatuses capable of providing a volume satisfying the performance independence relationship with respect to the volume designated to satisfy the performance independence relationship with the first volume.

10. A management system according to claim 1,
wherein the processor selects a plurality of candidates of migration destination storage apparatuses from the plurality of storage apparatuses, and
wherein the processor determines priority of each of the plurality of candidates in accordance with a remaining capacity of each of the plurality of candidates.

11. A management system according to claim 1,
wherein the memory apparatus stores cloud management information identifying a cloud type of each of the plurality of storage apparatus, and
wherein the processor refers to the cloud management information to select the candidate of the migration destination storage apparatus from storage apparatuses of a cloud type selected through an input device.

12. A management method for a management system of managing an information storage system including a plurality of storage apparatuses, the management method comprising:
referring, by the management system, to position management information indicating an installation position of each of the plurality of the storage apparatuses;
specifying, by the management system, a position of a first storage apparatus including a first volume and a position of a second storage apparatus including a second volume composing a copy pair with the first volume from the position management information;
determining, by the management system, a positional relationship before between the first storage apparatus and the second storage apparatus data migration from the specified position of the first storage apparatus and the specified position of the second storage apparatus,
determining, by the management system, a condition of a positional relationship after the data migration to be satisfied between a migration destination storage apparatus of data of the first volume and the second storage apparatus based on the positional relationship before the data migration in a case where the second volume is not to be migrated; and
selecting, by the management system, a storage apparatus which satisfies at least the condition of the positional relationship after the data migration from the plurality of storage apparatuses as a candidate of the migration destination storage apparatus.

13. A management method according to claim 12,
wherein the position management information indicates that the first storage apparatus and the second storage apparatus are installed at different positions, and
wherein the condition of the positional relationship after the data migration indicates that the migration destination storage apparatus is installed at a position different from the position of the second storage apparatus.

14. A management system managing an information storage system including a plurality of storage apparatuses, comprising:
a memory apparatus; and
a processor,
wherein the memory apparatus stores position management information indicating an installation position of each of the plurality of storage apparatuses,
wherein the processor specifies a position of a first storage apparatus including a first volume and a position of a second storage apparatus including a second volume composing a copy pair with the first volume from the position management information,
wherein the processor determines a positional relationship between the first storage apparatus and the second storage apparatus before data migration from the specified position of the first storage apparatus and the specified position of the second storage apparatus,
wherein, in a case where the second volume is to be migrated to a third storage apparatus, the processor determines a condition of a positional relationship after the data migration to be satisfied between a migration destination storage apparatus of data of the first volume and the third storage apparatus based on the positional relationship before the data migration, and
wherein the processor selects a storage apparatus which satisfies at least the condition of positional relationship after the data migration from the plurality of storage apparatuses as a candidate of the migration destination storage apparatus.
